(19) United States
(12) Patent Application Publication
(10) Pub. No.: US 2014/0114502 A1
(43) Pub. Date: Apr. 24, 2014

(54) METHOD AND SYSTEM FOR THE PREVENTION OF AUTOMOBILE ACCIDENTS CAUSES BY FAILURE TO OBEY ROAD REGULATIONS, A VEHICLE EQUIPPED WITH THE SYSTEM, A MANUFACTURING METHOD FOR THE SYSTEM, AND USE OF THE SYSTEM IN VEHICLES

(71) Applicants: Denis Hugron, St-Hubert (CA); Jean-Paul Aubin, Sainte-Julie (CA)

(72) Inventors: Denis Hugron, St-Hubert (CA); Jean-Paul Aubin, Sainte-Julie (CA)

(21) Appl. No.: 14/006,397

(22) PCT Filed: Mar. 21, 2012
(86) PCT No.: PCT/CA2012/000263

§ 371 Date: Dec. 10, 2013

(30) Foreign Application Priority Data
Mar. 22, 2011 (CA) 2,735,458

(51) Int. Cl. G07C 5/00

(52) U.S. Cl. CPC G07C 5/008
USPC 701/2; 701/1

(57) ABSTRACT

The present disclosure introduces an accident prevention method and system. The system is suitable for installation in a vehicle. A device measures at least one driving parameter of the vehicle. A controller is supplied with at least one traffic rule in order to detect, in response to the driving parameter, one or more traffic violations by a driver of the vehicle. A display, visible from outside the vehicle, shows data related to the traffic violations committed by the driver. A method of manufacture of the system, a vehicle equipped with the system, and uses of the system are also disclosed.

### TECHNICAL FIELD

The present disclosure relates to systems for the prevention of motor vehicle accidents. More particularly, the present disclosure introduces a method, a system, a vehicle equipped with the system, a method of manufacturing the system, and use the system for the prevention of car accidents.

### BACKGROUND

Many systems have been developed for installation in motor vehicles in order to reduce accidents caused by non-observance of traffic rules. Such problems are present for drivers of all ages, but are particularly prevalent among young drivers, leading to high number of deaths during the first years of driving.

International patent application published under number WO 0198794 describes a GPS-based excessive speed detector including a GPS receiver, a CPU, a database of speed limits per targeted geographic regions, and loudspeaker. The unit can be integrally mounted in a car or used as a standalone device. The central processing unit receives position data from the GPS receiver, uses the position data to calculate the vehicle speed, and questions the database for the speed limit in force at that position. The CPU compares the vehicle speed with the speed limit. A tonality informs the driver in case of excessive speeding.

WO 2009/113967 describes a traffic control system attempting to ensure a highest environmental and traffic safety level, using a GPS system. A browser stores an engine speed, a vehicle speed, and appropriate transmission gear ratio for the situation of the vehicle, and warns the driver to shift gears in order to reduce fuel consumption. In case where no shift is taking place, the police is informed and a fine is deduced from a bank account. This reference also monitors whether the vehicle speed exceeds a selected speed, or if the vehicle is about to enter a highway in the wrong direction, and further allows tracking of stolen vehicles.

US 2009/146844 discloses an electronic safety device for speed control that limits the maximum speed allowed for any vehicle, in real-time, based on the road being traveled. Combining the current GPS navigation technology and electronic speed limiter technology, this device monitors and controls the maximum allowed vehicle speed for a given road. This device recognizes the position of the vehicle, the actual speed, the speed limit, and limits the maximum speed for this position. The maximum allowed speed is programmed by software setting at the time of installation. For example, if you want to allow a 16-year old to drive up to 30 miles per hour (MPH) in an area where the posted speed limit is 25 MPH, it is possible to set a parameter OVER_SPEED_LIMIT (OSL) to +5.

US 2007/0239331 discloses a system, a method and an apparatus for automatically controlling the maximum speed of a vehicle according to the allowed speed limit on a highway on which a vehicle using a GPS receiver is travelling, a cellular network and a FM signal for determining a position of the vehicle in real time, using a computer control unit to control the maximum speed of the computer by incorporating devices limiting vehicular speed and governors for identifying operators of the vehicle using a keyboard and a scanner, and for receiving and sending user-specific information, for navigation purposes and for the remote operation of vehicle components.

GB 2445962 A discloses a satellite navigation and vehicle control system contained in a box that can be installed temporarily or permanently in a vehicle, including a GPS signal receiving unit and another receiving unit of a distant signal representative of the speed-sensitive conditions such as road work zones, speed limits and camera controlled zones. The signals received by these receivers are processed by a computer unit connected to a driver information display unit, and a vehicle speed control unit that controls the vehicle speed by means of a fuel system or engine management unit, when circumstances determine that a speed restriction should be imposed. The driver can select to override the speed control system in order to overtake, but this may not be allowed in case of a condition generated by at least one other signal. In this way, road safety is improved while allowing drivers to use their own judgment in conditions above critical conditions.

FR 2 861 032 describes a system for verifying the identification of a motor vehicle comprising at least one display located on the windshield of the vehicle and visible from outside of the vehicle, a communicating housing disposed within the vehicle and connected via a cable to the display and connected to a remote central database, the communicating housing being provided with a memory and with a GSM transceiver, or equivalent device, communicating via a cellular telephone network with the central database, the display being visible from the outside and showing data and information from the memory or received at the communicating housing from the central database.

Despite the presence of the above described solutions, there was a need for systems for the prevention of car accidents devoid of the drawbacks of existing systems.

There was also a need for systems without the drawbacks of existing systems and having one or more of the following characteristics:
greater efficiency;
reduction in losses of driver attention;
educational effect for the driver;
preventive effect for the driver;
greater dealership traffic;
documentary effect; and
reduction in accidents caused by a momentary loss of attention, lack of experience, emotions and/or fatigue of the driver.

There was also a need for vehicles for preventing auto accidents and devoid of the drawbacks of existing systems.

There was also a need for vehicles to for preventing car accidents.

There was also a need to educate the driver and/or assist the driver in the learning process and/or reducing the risk of vehicular accident and/or reducing the risk of accidents in the vehicle's environment.

There was also a need for vehicles for preventing auto accidents while inducing the driver to maintain his attendance at a car dealership.

There was also a need for a system to inform people in the vicinity of a vehicle of a potential and/or imminent danger and allow them to take their own measures for reducing their exposure to risk and thus reduce the occurrence of accidents.

There was also a need for a system for documenting the behavior of the driver and, if desired, for printing a report of the behavior.

### SUMMARY

The present disclosure introduces a system for the prevention of accidents. The system is suitable for installation in a vehicle. The system comprises a device for measuring at least one driving parameter of the vehicle. A controller is supplied with at least one traffic rule in order to detect, in response to the driving parameter, one or more traffic violations by a driver of the vehicle. A display is visible from outside the vehicle to show data related to the one or more traffic violations.

In another aspect, the present disclosure introduces a method for the installation, in a vehicle, of a system for the prevention of accidents.

A further aspect of the present disclosure introduces a vehicle equipped with a system for the prevention of accidents.

Another aspect of the present disclosure introduces the use of a system for the prevention of accidents.

Yet another aspect of the present disclosure introduces an accident prevention method. The method comprises a step of measuring at least one driving parameter of the vehicle. A controller supplied with at least one traffic rule detects one or more traffic violations by a driver of the vehicle in response to the driving parameter. Thereafter, data related to the one or more traffic violations is displayed so that it is visible from outside the vehicle.

The foregoing and other aspects will become apparent from reading the following description, which discloses some non-limiting examples of possible embodiments. These embodiments only serve as examples by reference to the following drawings.

### BRIEF DESCRIPTION OF THE DRAWINGS

Example embodiments of the present disclosure will be described with reference to the following drawings:

FIG. 1 is a schematic and detailed view of a system of the present disclosure as used in Examples 1 to 4 below;

FIG. 2 illustrates an example of an ‘Ange Gardien™ system’ connected to a vehicle and introduces light displays;

FIGS. 3-8 illustrate various operating sequences of the Ange Gardien™ system and corresponding light displays;

FIG. 9 summarizes examples of possible features of the Ange Gardien™ system;

FIG. 10 schematically shows a sequence of operation of an Ange Gardien™ system according to the present disclosure;

FIG. 11 schematically and generally shows components of a system according to an embodiment of the present disclosure (Ange Gardien™) for the prevention of car accidents, and interconnection of components of the system;

FIG. 12 shows a flowchart of the operation of the system of FIG. 11 in the case of excessive speeding;

FIG. 13 schematically shows components of a system according to an embodiment of the present disclosure (Ange Gardien™+SV-go®) for the prevention of car accidents, and interconnection of components of the system;

FIG. 14 shows a schematic side view of a vehicle equipped with a system for the prevention of accidents according to an embodiment of the present disclosure, including a display on the rear window, on the front window on the left rear window, and a display device on the roof of the vehicle, all in a driver training situation;

FIG. 15 shows a schematic rear view of the vehicle of FIG. 14;

FIG. 16 shows a schematic front view of the vehicle of FIG. 14;

FIG. 17 shows a side view of a vehicle equipped with a system for the prevention of accidents, with as its driver, along with a vehicle not so equipped in front of the equipped vehicle and with a cyclist traveling behind the equipped vehicle, the system displaying an indication that the driver is in training;

FIG. 18 shows a side view of a vehicle equipped with a system for the prevention of accidents, with as its driver, along with a pedestrian about to engage in a crosswalk while the vehicle is approaching;

FIG. 19 schematically shows a side view of a vehicle equipped with a system for the prevention of accidents according to an embodiment of the present disclosure, including a display on the rear window, on the front window on the left rear window, and a display device on the roof of the vehicle, all in a situation of a driver on probation;

FIG. 20 schematically shows a rear view of the vehicle of FIG. 19;

FIG. 21 schematically shows a front view of the vehicle of FIG. 19;

FIG. 22 shows a side view of a vehicle equipped with the system for the prevention of accidents of FIGS. 20 and 21, with its driver, also showing a vehicle not so equipped rolling in front of the equipped vehicle and a bicycle rolling behind the equipped vehicle, in a situation where the display system shows “driver on probation”; and

FIG. 23 shows a side view of a vehicle equipped with a system for the prevention of accidents, with as its driver, along with a pedestrian about to engage in a crosswalk while the vehicle is approaching and while the system is displaying “driver on probation”.

### DETAILED DESCRIPTION

In the present specification, the same reference numerals are used to represent like elements throughout the various drawings.

Various aspects of the present disclosure generally address one or more of the problems introduced above. Thus, the present disclosure introduces systems for the prevention of car accidents caused by non-compliance with traffic rules and, in particular, excessive speeding, particularly among young people between 16 to 25 years. It also introduces manufacturing processes for these systems.

The present disclosure also introduces vehicles equipped with these systems, and vehicles equipped with these systems and with a second system intended to increase traffic at a dealership.

The present disclosure also introduces the use of such a system in a vehicle to prepare a report on the behavior of a vehicle equipped with this system.

A system of the present disclosure is used in a vehicle to educate the driver and/or assist the driver in the learning process and/or to reduce the risk of an accident of the vehicle and/or to reduce the risk of accident with the vehicle's environment.

A system of the present disclosure can also inform people in the vicinity of a vehicle equipped with this system a potential risk and/or threat to enable them to take their own measures to reduce their exposure to risk and therefore reduce the frequency of accidents.

The combined use of systems of the present disclosure with a system encouraging loyalty to car dealers is also an aspect of the present disclosure.

The following terminology is used in this description:
Vehicle: in the context of the present disclosure, this term refers to any motorized machines used by one or more people to move from point A to point B, including without limitation: a car, a motorcycle, an all-terrain vehicle (ATV), a scooter, an electric bike, a boat, a water scooter, a snowmobile, an ultra light aircraft, etc.
Accelerometer: The principle of all accelerometers is based on the fundamental law of dynamics F=MA (F: force, M=mass, A: acceleration). An acceleration applied to a mass induces a force on the mass. By detecting the induced force on this mass, the value of the acceleration can be deduced. A constant speed in a straight line does not induce acceleration, a curved path (turn) then induces a centrifugal acceleration force. A significant acceleration subject passengers and their vehicle to large forces that can lead to slippage of the vehicle when the vehicle cannot oppose to this acceleration a sufficient frictional force on the ground. This may cause skidding of the vehicle in a curve, due to excess speed (racing cars accelerating in curves can generate up to 2 g, which is twice the force of gravity).

A first aspect of the present disclosure comprises systems to for preventing accidents caused by the driver of a vehicle, including accidents caused by non-compliance with traffic rules, especially by non-compliance with speed limits, the system comprising:
a) a secured access transceiver control device positioned in the vehicle, configured to:
   measure parameters related to the position and velocity of the vehicle with respect to the external environment and, optionally, for measuring the time of measurement,
   measure parameters related to the acceleration, for example for measuring parameters related to the accelerations in three axes of the vehicle, and
   transmit the data from the measurements of the parameters to a central unit;
b) a central processing unit, local or remote to the vehicle, for processing data transmitted by the transceiver device, the processing unit being configured to analyze the data relative to the traffic rules and to develop instructions for:
   control of the vehicle, for example control of the vehicle electrical system and more particularly control of the engine' ignition, and/or
   display of information on the behavior of the driver and/or warnings, for the conductor and/or for a person located near the vehicle, and/or
   transmission of instructions to the driver and/or transmission of instructions to a person located near the vehicle;
c) a controller of the vehicle, e.g. a control of the vehicle's electrical system or engine, the controller being configured to control (e.g. decelerate and/or standby and/or block) operation of the vehicle when it is so instructed, for example via the transceiver device or directly from the central unit to which the control system is directly connected, for example via a telephone exchange;
d) a display of information related to the behavior of the driver and/or warning data, for example received from the transceiver and/or of the central unit and/or the system control device, the display being made visible (internally) on the front windshield of the vehicle and/or visible for a person located outside of the vehicle, displaying occurring when the display device is so instructed, for example when the display device is instructed through the transceiver device or directly from the central unit to which the display device is directly connected, and displaying being achieved by any available means, including a visual, sound or vibration form; and/or
e) a transmitting device of instructions for the driver and/or for a person located outside of the vehicle, transmission being perceivable by the driver of the vehicle and/or by the person located outside the vehicle, transmission of information taking place when the transmitting device is so instructed, for example via the transceiver or directly from the central unit to which the transmitting device is directly connected, transmission of instructions being performed by any available means, including a visual, sound or vibration form.

The systems for the prevention of car accidents can have one or more of the following characteristics:
the system is configured to display warnings and/or information and/or to transmit instructions upon a first case of non-compliance with traffic rules and/or to prevent starting of the vehicle driver repeatedly ignores the warnings and/or if a major infraction is committed;
the system is installed and/or modified and/or removed and/or configured by an authorized vehicle dealer, for example by the authorized dealer who sold the vehicle;
the system additionally includes a physical interface usable to connect the system to perform various modifications and/or transfer of data in the database that was used to program the system according to the profile of the driver (e.g. as a of function age, sex, history);
the system comprises for example a driver identification device to associate their identity with occurrences and nature of anomalies while driving under their responsibility and/or to give a conductor access to the controls of the vehicle after the identification device has validated that the conductor is an authorized person;
the system comprises a decision algorithm for determining the level of action (restrictions on the driver and/or on the vehicle) according to the nature and severity of the events (weight coefficient) as well as their frequencies and simultaneity of their occurrence, and
The system has a data storage unit connected to the central processing unit of the system.

For example, these systems may have an accelerometer for detecting one or more of the following activities:
dangerous driving and/or loss of attention;
cutting the path of another vehicle, including at high speed on a highway, and/or including avoidance maneuvers in urban areas.

The accelerometer can be a vertical axis accelerometer able detect include the following activities:
rolling on unstable road shoulders and/or on lane exit warning marks and/or driving off the road, and
axial impact, obstacle bumping and/or hit and run maneuvers.

Road regulation information may be resident in the control device including in order to make it self-sufficient in case of loss of communication with the central unit.

For example, systems for the prevention of automobile accidents may include:
an alcohol sensor, which for example detects alcohol in the passenger compartment of the vehicle and/or;
a driver identification device that can be a fingerprinting system, by a retina reader or the like, this device being possibly integrated into the system, the identification being done by specific module or by a module integrated in other elements necessary for driving the vehicle such as: the steering wheel, the gear knob, the handbrake, etc.

In another embodiment, the systems of the present disclosure includes a voice communication system such as a cell phone, or a microphone and a speaker, allowing the driver of a vehicle equipped with the system to communicate with a family member and/or the police or a car dealers and/or having emergency system connected to a 911 call center as used in Canada.

For example, these systems for the prevention of car accidents are configured to allow a certain tolerance of exceeding speed limits, in order to not prevent all issuances of speeding tickets by the police.

The systems can be configured to display, on the windshield, a first signal of a certain color to warn the driver that the speed limit is exceeded and/or configured so that if the driver continues to accelerate despite exceeding the speed limit, the color changes to another color, for example, according to the sequence of green, yellow, and red, used alone or in combination with flashing signs, letters, characters, symbols or Figures, including symbols accredited colors for color blind persons.

For example, the systems are configured so that if the speed limit is exceeded beyond a set tolerance limit, an engine control system such as an engine cut-off is automatically triggered, for a limited and/or unlimited time period.

The systems can be configured so that operation of the motor is blocked for an indefinite time period after a number of allowed vehicle overtaking events and/or configured to send a message requesting help for a possible intervention and/or to allow voice communication with the driver and/or so that any attempt to dismount an element of the system prevents the vehicle from starting.

For example, the systems are configured so that all motor control as all stoppages and/or slowing down events imposed by the system are recorded in the central unit to document non-compliance of traffic regulations by offending drivers.

In the system of the present disclosure, programming of parameters related to speed limit tolerance varies according to a case and/or history of the driver and/or recommendations of the police and/or of insurers.

For example, a sensor and/or an antenna and/or a sequential alarm are located in the windshield, sequential alarm being able to project a signal onto a screen upon every infraction committed by the driver.

According to another embodiment of the present disclosure, all information related to the module are stored in the central unit to document the behavior of the driver and to manage information stored in relation to:
interim and/or preventive measures, for a low risk or corrigible driver, and/or
a temporary or provisional driving ban for the driver of the vehicle when the driver is at high risk.

In another embodiment, inasmuch as a car dealer adheres to a program associated to the system for the prevention of motor vehicle accidents (among youths of 16-25 years of age) caused by non-observance of traffic rules (especially speeding), the car dealer may intervene with the vehicle under control, for example by immobilizing the vehicle at risk.

The systems of the present disclosure in which the device d) for displaying warning data received from the transmitter and/or the central unit displays a visible warning to a person outside of the vehicle, such as a cyclist, a motorcyclist, a skateboarder, a pedestrian on rollerblades, or a person in another vehicle located near the vehicle, are of particular interest.

The systems of the present disclosure in which the device d) for displaying a visible warning to a person outside of the vehicle is constituted by one or more of the following means: displays on the rear window, on a side window, or the roof of the vehicle, displays embedded in the body of the vehicle, or in vehicle's signaling system, are also of particular interest.

The display on a window of the vehicle can be made to only be visible by a person present in the vehicle, to only be visible by a person located outside of the vehicle, or to be visible at once by a person present in the vehicle and by a person located outside of the vehicle. For example, this display is visible to a person outside of the vehicle, at a distance between 50 cm and 3 meters, for example at a distance of between 1 meter and 3 meters.

For example, all displays installed in the vehicle can simultaneously display warning data received from the transmitter and/or from the central unit.

The warning data can remain displayed in a manner visible to a person located outside of the vehicle until intervention by an authorized person, such as a car dealer and/or until the system instructs the display to stop displaying the warning data.

The systems of the present disclosure may additionally include an additional display device located outside of the vehicle, visible by a person located outside of the vehicle, and displaying a qualification associated with the driver of the vehicle. The additional display device displays one or more incremental qualifications, such as: driver under impending disqualification, driver on probation, driver under training, level 1 driver, level 2 driver, driver undergoing qualification, and qualified driver.

A second aspect of the present disclosure comprises methods for the manufacture of a system as defined in the first aspect of the present disclosure and is more particularly constituted by processes consisting in the assembly and/or the establishment of the system components using known assembly and/or methods of installation.

A third aspect of the present disclosure comprises motor vehicles characterized in that they are equipped with a first system according to the first aspect of the present disclosure, or with a system obtained by a manufacturing process according the second aspect of the present disclosure, and equipped with a second system to increase traffic at a car dealership, for example by a guarantee scheme paid by the buyer of the vehicle or implicitly included in the purchase price of the new or used vehicle.

The second system can increase traffic at a car dealership through a program guaranteeing the repair of a windshield through a guarantee program, in which a dealer participates in the guarantee program and in which a plurality of windshields are covered by the warranty program in exchange for a premium paid by the owner of a vehicle equipped with the windshield, the system inducing the owners of guaranteed windshields to have repairs made at a vehicle dealer participating in the guarantee program, the second system comprising:
a calculation unit configured to:
   assign a car dealer identification code to a car dealership;
   assign to each of the windshields of the plurality of windshields an identification code corresponding to a windshield; and
   to relate each windshield to a car dealership by associating the identification number corresponding to a windshield to the identification number of a corresponding car dealership;
a data storage device configured to:
   memorize, for car dealership, a corresponding identification code;
   memorize, for a each of plurality of windshields, a corresponding windshield identification code;
   memorize a relationship between the windshield identification code for each of the windshields and the corresponding car dealership identification code, and
optionally, a windshield break detector being, for example, connected to the calculation unit;

in which guaranteed windshield owners have the possibility of having their windshield repaired free of charge at the participating dealer.

As an option, only a car dealer adhering to the warranty program of the second system may be allowed to intervene with the immobilized vehicle.

For example, each vehicle can be equipped with a marked windshield and, optionally, the calculation unit may be configured to connect each windshield to a car dealer selling vehicles of the same brand as the vehicle equipped with the windshield.

Each vehicle may be equipped with a windshield of a given brand, in which the calculation unit is configured to connect each windshield to a car dealership having technical expertise in this brand of vehicles.

For example, each vehicle of this disclosure is equipped:
with a branded windshield to a brand, the calculation unit being configured to connect each windshield to a dealer using genuine parts to repair windshields; and/or
with a branded windshield, the calculation unit being configured to connect each windshield to a car dealership having sold the vehicle equipped with the windshield.

Each vehicle can also be equipped with a windshield of a particular brand and the calculation unit may be configured to calculate, from stored data about broken windshields causes, a premium to guarantee a specific windshield of the plurality of windshields.

For example, data on broken windshields causes may include one or more elements selected from the group consisting of: the rate of occurrence of damage to windshields, the nature of the damage to windshields, the costs for repairing the windshields and a combination of these elements.

Each vehicle of the present disclosure may additionally comprise, for each of the plurality of windshields, a warranty certificate and a sticker for application to the windshield, the sticker comprising for example the serial number of the vehicle. For example, the sticker can possess specific qualities enabling it to increase the quality of the reflection of the display system such as a better contrast, a better focus of information, including simple implementation or combination of techniques such as Fresnel lenses and light polarization. Optionally, the sticker can be marked with the windshield identification code.

For example, each vehicle can be equipped with a branded windshield and the calculation unit may be configured to calculate, for the car dealership, an actuarial reserve to secure future claims made for the car dealership, under the warranty program for windshields related to the car dealership.

Each vehicle may be equipped with a windshield of a given brand and the calculation unit may be configured, or not, to calculate for an automobile dealership an actuarial reserve to secure future claims made for the car dealership, under the warranty program for windshields connected related to the car dealership.

A fourth aspect of the present disclosure relates to uses of a system as defined in the first aspect of the present disclosure, or uses of a system as obtained by one of the processes defined in the second aspect of this disclosure, or uses of a vehicle as defined in the third aspect of the present disclosure, to prepare a report on the behavior of a driver of a vehicle equipped with such systems, at the same time not necessarily imposing restrictions to the driver and/or to the vehicle deviating from the traffic regulations.

The methods of the present disclosure for warning people in the vicinity of the vehicle of potential hazards related to the proximity of a vehicle equipped with the system and/or upon occurrence of a potential hazard because of non-compliance to traffic rules by the driver of the vehicle, are of particular interest.

Uses of the present disclosure to educate the driver of a vehicle by inducing them to behave in accordance with the rules of traffic, are also of particular interest.

The uses to warn drivers of vehicles in the vicinity of the vehicle of a potential danger for them so that they may adapt their own driving behavior accordingly, are also particularly interesting.

The use of the present disclosure can allow warning persons, pedestrians, cyclists, motorcyclists of a potential danger and warning drivers of vehicles in the vicinity of the vehicle of a potential danger so that they may adapt their behavior accordingly.

Uses of the systems and vehicles of the present disclosure, for reducing the risk of accidents for people in the vicinity of the vehicle, such as pedestrians, cyclists, motorcyclists and drivers and for drivers of vehicles moving near the vehicle, so that they may adapt their behavior accordingly, are of particular interest.

A sixth aspect of the present disclosure comprises the use of vehicles of this disclosure for reducing the number of accidents caused by non-compliance with traffic rules, while increasing traffic at dealerships selling vehicles of the same brand.

### Example Embodiments of the Disclosure

The following examples are provided for illustration of an embodiment of the present disclosure only and should not be construed as a limitation of any aspect of the present disclosure.

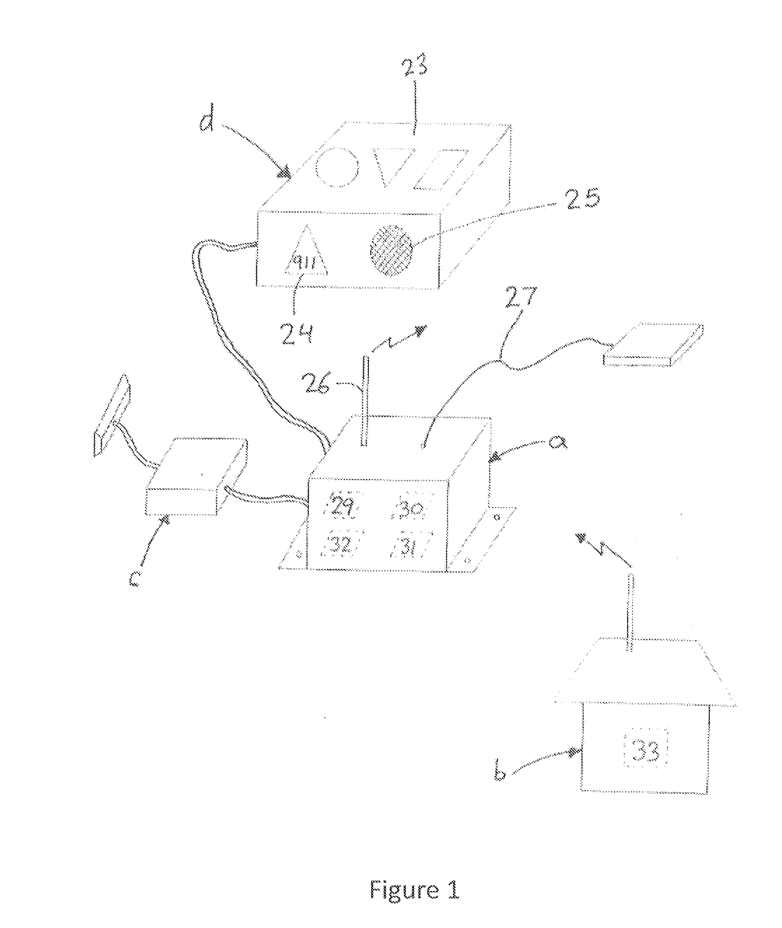

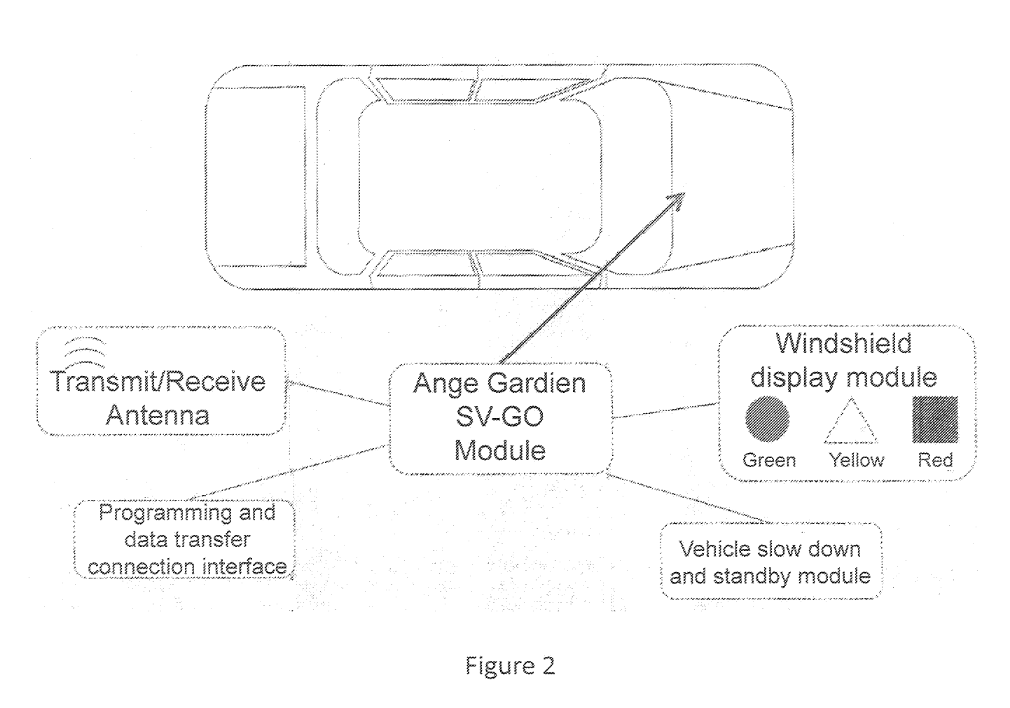

Referring now to the drawings, FIG. 1 is a schematic and detailed system of the present disclosure as used in Examples 1 to 4 below. FIG. 2 shows an example of Ange Gardien™ system connected to a vehicle and introduces light displays.

### Example 1

### Vehicle Equipped with a System to Prevent Car Accidents

Considering both FIGS. 1 and 2, a motor vehicle (1) is equipped with an Ange Gardien™ module (2) as shown in FIG. 1. The Ange Gardien™ module (2) consists of elements (a, d, c) described hereinabove, installed in the vehicle. The module (2) is connected by a wire connection of the serial type for transferring data to the warning data display device (d), by a wire connection to the control device of the vehicle (c), and by radio link to the central unit (b).

The module (2) comprises a circuit GM862 module from TELIT® that supports both GPS (location) functions and GSM (wireless communication) functions, providing bidirectional exchange of data and voice and a serial type liaison to the computer. The calculation function is provided in the first case by a portable computer in the vehicle; it ensures the calculation function, generates commands and collects data from sensors in the system.

The module (2) also includes an ADXL213 accelerometer type from Analog Devices™, which as a sensing range of +/−2 g with a resolution of 6 mg. The three analog signals of the respective X, Y, Z axes are converted to digital signals in 8-bit coding, and each is fed to the computer via serial link.

The module (2) also includes electronics required to interface and amplify signals from the microphone and to the loudspeaker.

The data display device includes, in addition to three (3) banks, LEDs representing symbols (circle, triangle and square, respectively green, yellow, red), a vapor detection system alcohol, a 911 button for Canada, and an integrated microphone and speaker. Detection of alcohol vapors is made by SnO2 sensor technology (MQ3 sensor from Hanwei Electronics™). It is based on the use of three of these sensors in the following configuration to enable the detection despite a drift problem associated with this type of sensor technology. A sealed sensor having a gas volume without contact with the interior air is considered as a reference. Two other sensors are both immersed in the monitored atmosphere. A fan device alternately brings gas from the front of the display (facing the driver) or in front of the windshield to detect a differential change between the front and rear of the display.

The following examples reuse the configuration described in Example 1.

Control of the motor can be done through a standard diagnostic port and/or by interfacing with one or more sensors, for example and without limitation, a throttle position sensor, a speed sensor, an air flow sensor, etc.). For older cars, module (c) may include an interface on the injection signals or the ignition signals.

A deceleration module made part of the vehicle control device (c) is connected with the motor vehicle (1).

The monitoring functions other than those in respect of speed limits monitor drift of the driving path, such as rolling on the shoulders of the road (natural irregularity or ridges used to detect movements off a driven lane on a highway). In extreme cases, detection that the vehicle is driven off the road may quickly limit the speed of the vehicle (possibly also placing an automatic 911 call) to prevent or limit the consequences of an impact on an obstacle. This function is mainly provided by a vertical axis accelerometer.

Element (23) is a display module, (24) is a panic button, (25) is the alcohol vapor detector based on the MQ3 sensor from Hanwei™, (26) is a radio antenna, (27) is a GPS antenna, (29) is a TELIT™ GM862 GSM communication module, (30) is a GPS module, (31) is an ADXL213AE Analog Devices™ (ref sku: SEN-00843) accelerometer, (32) are data from the backup/roadmap/speed interface and (33) is the data provided by the central unit (b), including, for example, road aps from Navteq™ and speed limits.

When the ignition is switched by the driver, the system (2) changes from standby mode to active mode.

The driver is identified by a fingerprint using a scanning device.

An alcohol vapor level of in the immediate vicinity of the driver is tested with the MQ3 alcohol vapor detector (25) from Hanwei™.

Once these two criteria have been verified, the Ange Gardien™ system applies the preference profile configuration associated with the identified driver, particularly with regard to the display of a message, presented when a certain number of violations having certain severity within a reasonable time, of the severity of faults, the frequency warning displays, maximum occurrence, emergency call number, etc. The system then allows the engine to start.

When the vehicle starts, the Ange Gardien™ system is activated and the positioning and speed information collected by the module (2) for the moving vehicle is stored in a database (not shown) of the module (2).

The module (2) compares these data, notably the vehicle speed with the speed limit in the location of the vehicle (1).

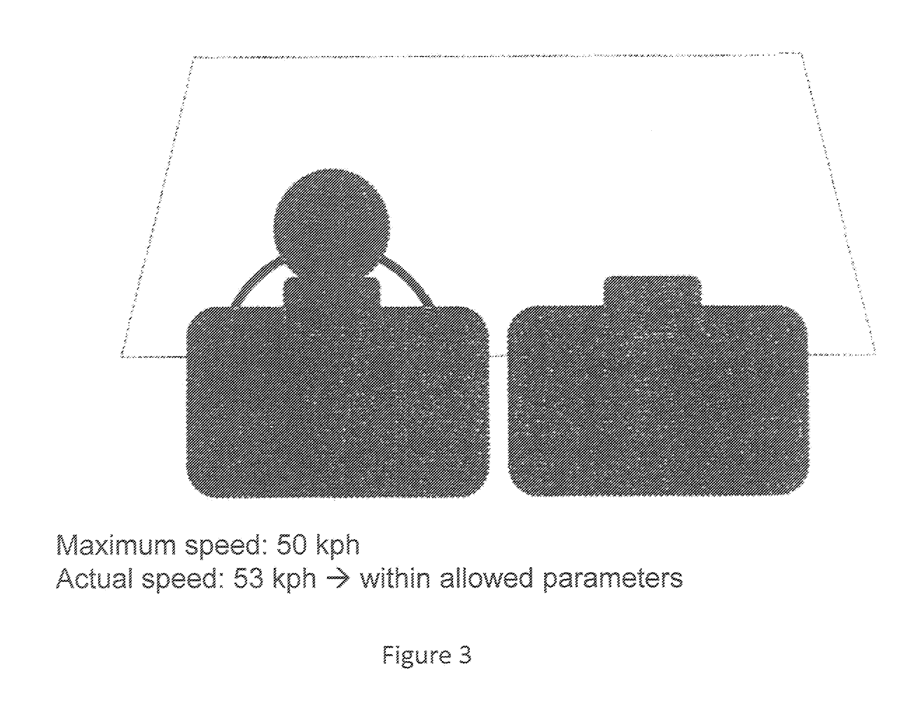

FIGS. 3-8 illustrate various operating sequences of the Ange Gardien™ system and corresponding light displays. In the absence of excess speeding, of alcohol vapor, of dangerous behavior or loss of vehicle control, no signal or command is sent by the module (2) to the display module (d) (FIG. 3).

As soon as a first excess speeding or dangerous behavior event is detected, the CPU evaluates whether the excess is acceptable, is a minor infraction, or a major infraction indicative of dangerous driving. For example, an avoidance maneuver detected by the acceleration sensor when the driver needs to bypass the inadvertent opening of the door of another vehicle would not be considered major this seldom occurs. In contrast, events such as cutting the path of another vehicle highway at high speed, with or without large variations in the axial acceleration during acceleration or deceleration of the vehicle, are considered major infractions. Bringing a vehicle too fast and dangerously in front of another vehicle after overtaking is sometimes called a “fishtail” maneuver.

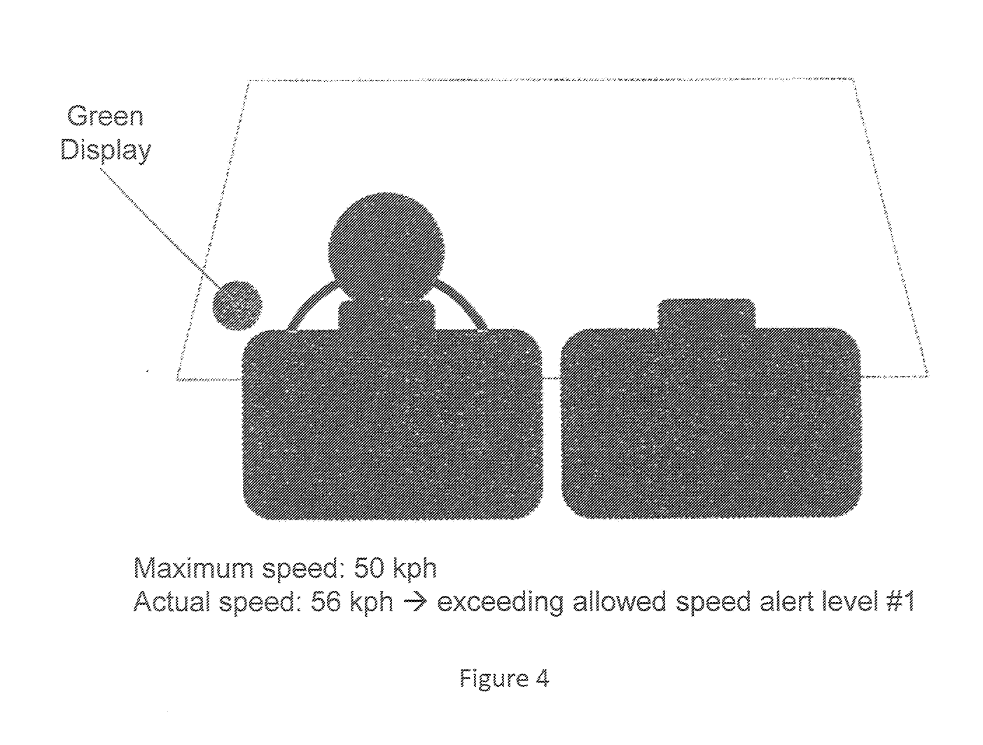

The Ange Gardien™ module includes an original algorithm that weights speed, acceleration and frequency criteria, with various severities to activate different alarm and restriction levels on vehicle, eventually leading to its immobilization and even to a concerted action with the police.

Where a minor infraction is detected, the Ange Gardien™ module sends a message to the central unit and transmits a command to the display module (d) that projects a green circle on the windshield (8) to symbolize a minor infraction and to inform the driver that his behavior is similar to an infraction (FIG. 4).

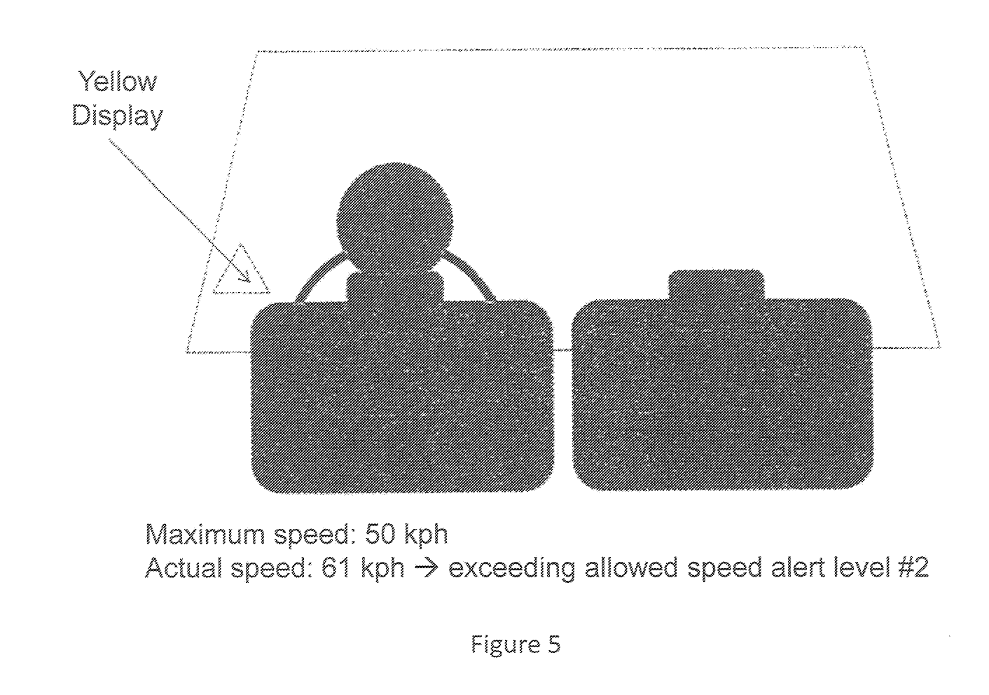

When a second excess speeding event is found on a second road location, the transmission and analysis process is repeated. The second infraction is classified at risk for the driver and for other users of the road on which the driver circulates, a signal is sent instantly by the Ange Gardien™ module to the central unit and to the and display module (d) and a yellow triangle visibly appears on the screen of the windshield (8), informing the driver that he is in an infraction situation (FIG. 5).

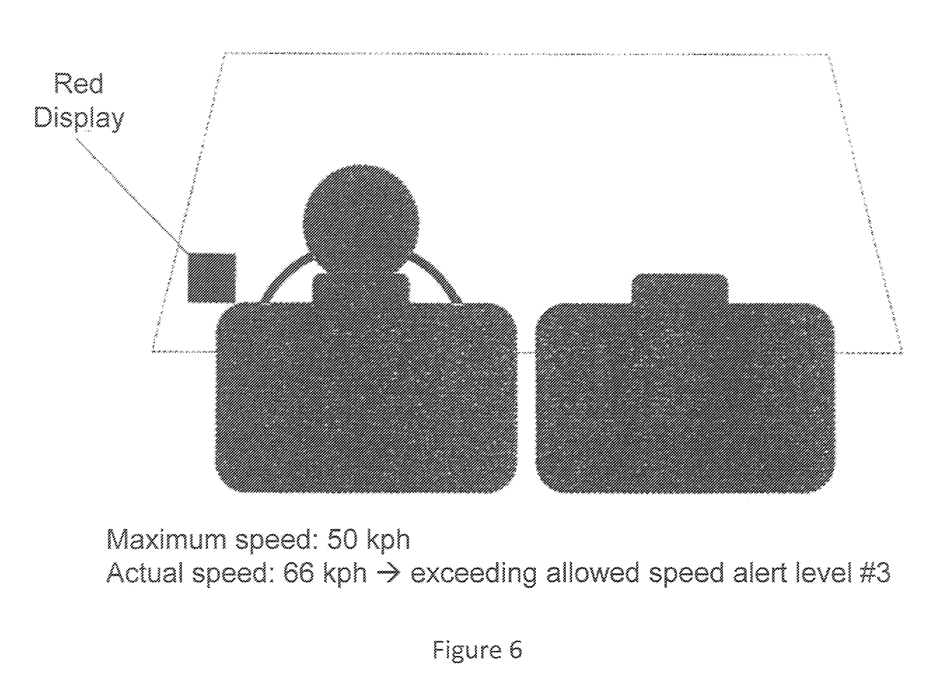

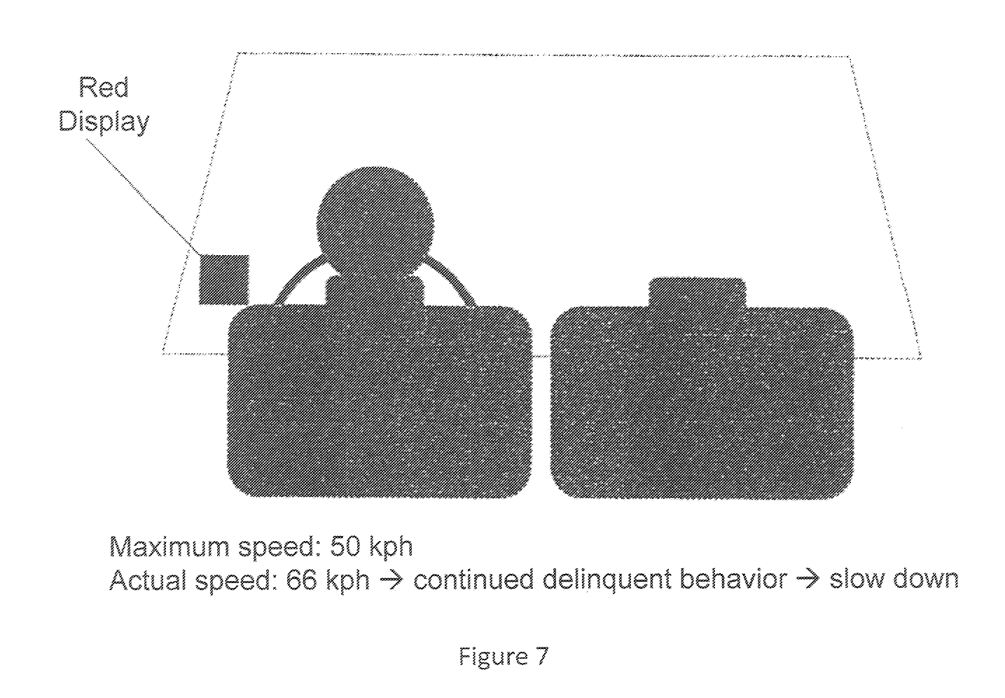

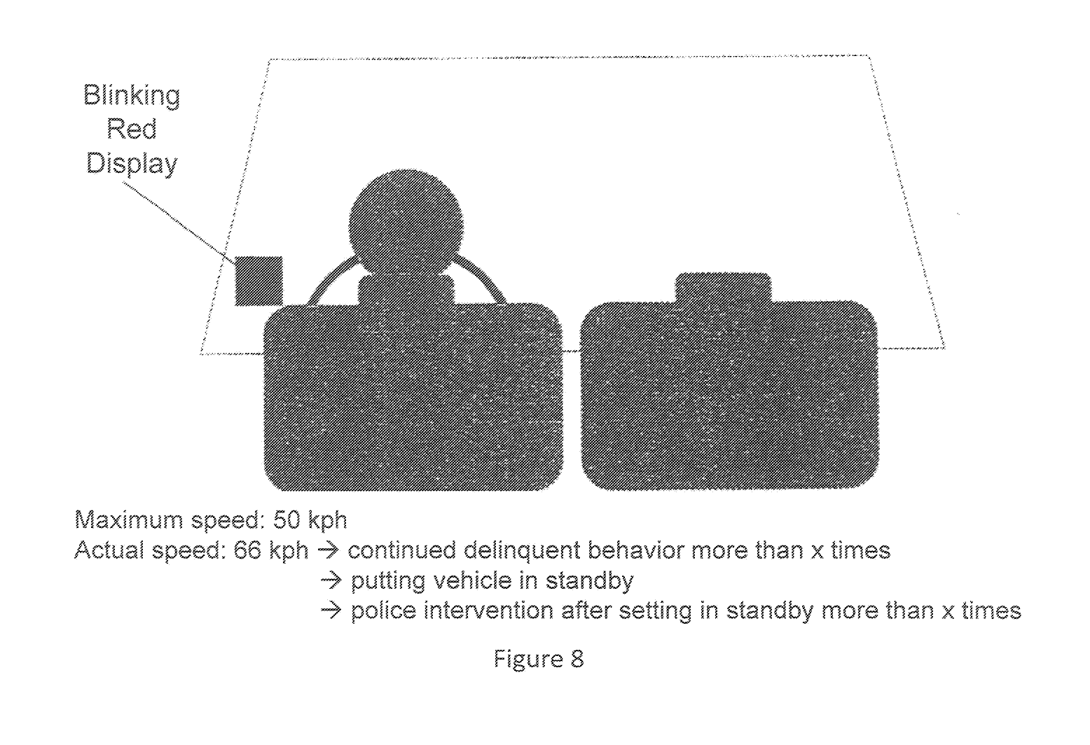

Display of a red square corresponds to a high-risk behavior that is not tolerable in the current traffic area such as when the vehicle (1) is doing 80 kilometers/hour (km/h) in a school zone to 30 km/h (FIG. 6). The red square is also shown upon detection of abnormal alcohol vapors in the driver's environment, or when the accelerometers detect that the vehicle is driven off the road. If the driver persists in the offending behavior, display of the red square can be accompanied by an imposed deceleration of the vehicle (FIG. 7). The persistence of such behavior can then cause a flashing display of the red square and putting the vehicle in standby mode (FIG. 8).

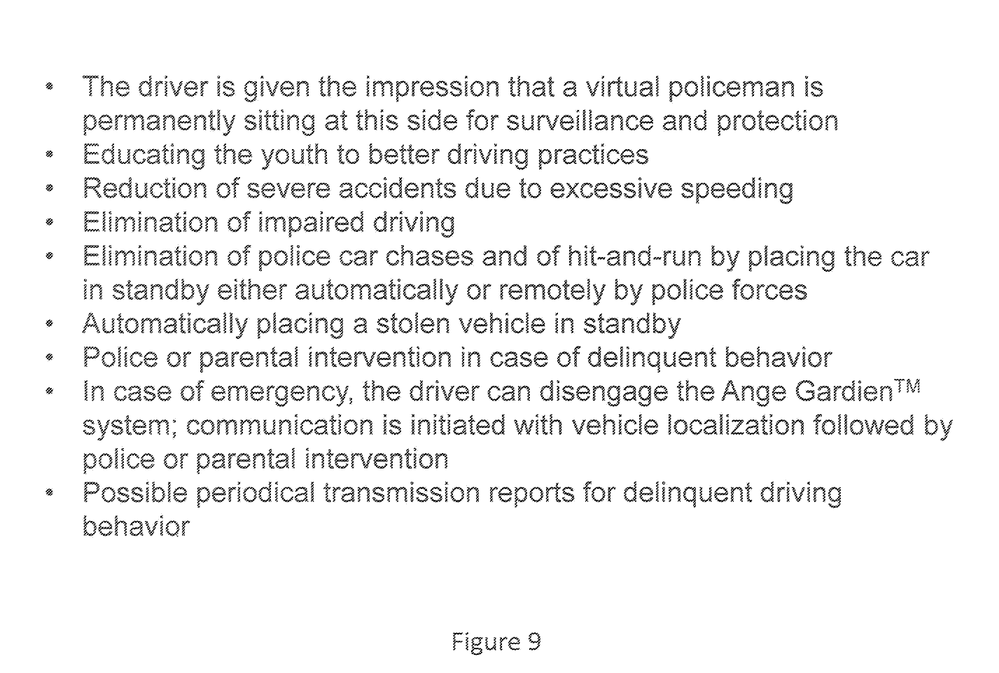

FIG. 9 summarizes examples of possible Ange Gardien™ system characteristics.

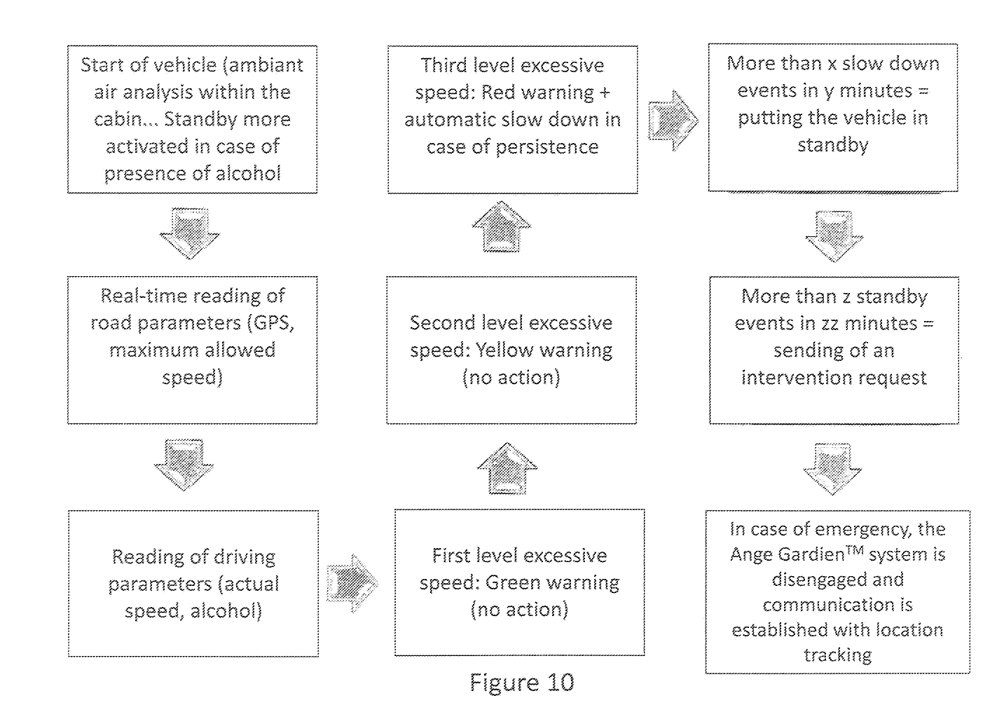

The Ange Gardien™ module (2) is configured so that the vehicle is immobilized by the deceleration control device of vehicle (c) under the conditions defined in FIG. 10, which schematically shows a sequence of operation of the Ange Gardien™ system according to the present disclosure. It does however allow a brief excess speeding for overtaking while successive overruns are not allowed.

The immobilized vehicle (1) cannot be driven by the driver, or may only be allowed to move at very low speeds; however the engine continues running e.g. for heating or cooling of the cabin. An emergency signal is sent to the central unit (not shown) that reports to the police.

Stored information about minor infractions is for example sent to the insurance company that decides to increase the premiums and to the police that issues a fine.

The determination of dangerous driving is not solely based on the speeding aspect.

The determination of dangerous driving even while meeting the speed limit is based on trajectories imposed on the vehicle (and on people) by accelerations beyond a threshold to be determined by normal use conditions of a vehicle.

A lateral accelerometer (to the left or to the right) can determine that the vehicle is cutting another one, or detect sudden evasive maneuvers. An axial accelerometer (from front to rear) can detect abrupt maneuvers as car collisions, excessive acceleration or deceleration, being, in most cases, signs of a significant increase in risk of loss of vehicle control or warnings of loss of control.

The ADXL213AE vertical accelerometer monitors whether an excessive level of oscillation of the vehicle is met due to rolling on ridges used to detect movements off a driven lane on a highway (bumping on the side of a highway or raised road shoulder), to running on unstable road shoulder (poor centering of the vehicle on the road axis) or even in the case of impending driving off of the road or extreme off-road driving when no road is present on a digital map. The system may impose a speed limit of 100 km/h (maximum allowed speed in Canada). Similarly, such a speed limit may be imposed in case of loss of GPS signal, as may occur, for example, in the case of tunnel crossing or in a zone not covered by the satellite.

The system is equipped with an emergency module (not shown), such as a button, that can be activated by the driver of the vehicle in an emergency, for example in need to bring a patient to the emergency room of the nearest hospital. The activation of the emergency unit causes the disconnection of the deceleration system, uses a light signal to inform the driver that the emergency mode is activated and sends a signal to the police.

In this case, the central unit then communicates the location coordinates of the vehicle and its speed. The police will be able to check the validity of disabling the system and may intervene in a timely manner with the vehicle and/or by voice communication with the driver.

Once the vehicle has stopped and the ignition is turned off, the Ange Gardien™ system goes into standby mode, that is to say, ensures respect for the integrity of the system and continue to record the vehicle's position and speed and inform the central unit in the event of unintended movement (vehicle being stolen), or lateral or axial shock.

Similarly, the 911 emergency function can be activated and lead to police action as described in this disclosure.

On identified race tracks, such as on drag racing circuits, the Ange Gardien™ system can optionally be made to not take the vehicle speed into account.

### Example 2

### Vehicle Equipped with a System to Prevent Car Accidents

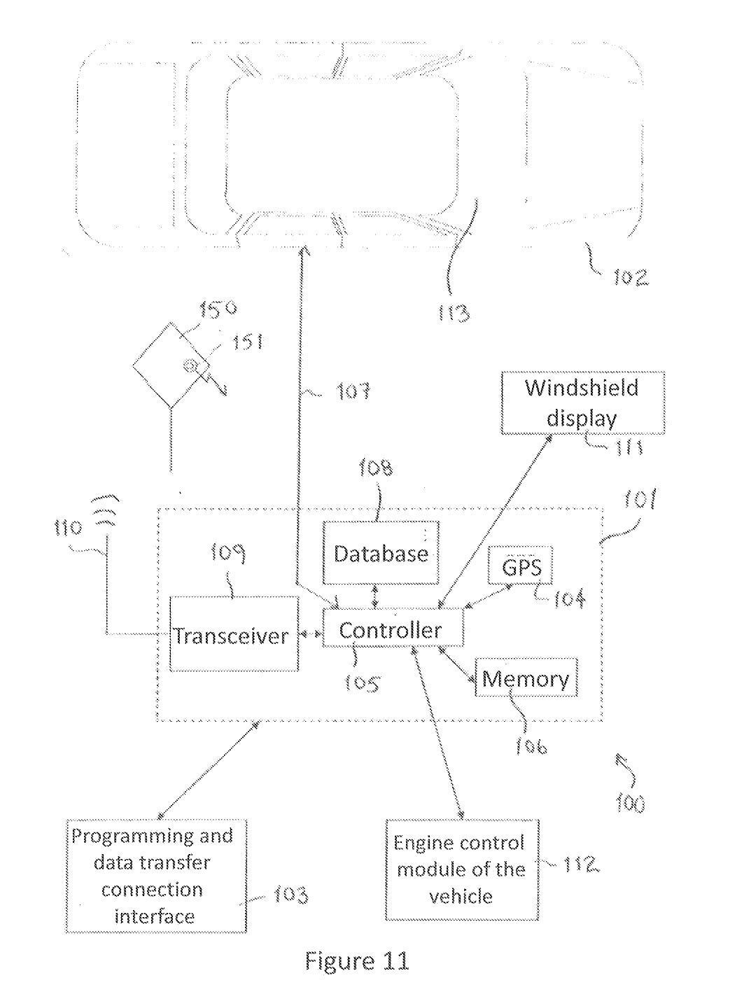

FIG. 11 schematically and generally shows components of a system according to an embodiment of the present disclosure (Ange Gardien™), for the prevention of car accidents and for interconnection of system components.

An auto accident prevention system 100, particularly but not exclusively for young people aged 16-25, the accidents being for example caused by non-observance of traffic rules, especially but not exclusively due to excess speeding, includes a first controller 101, mounted in a motor vehicle 102.

In the present disclosure, the term “motor vehicle” designates any motor vehicle (car, van, truck, trailer truck, motorcycle, etc.) that can travel on public roads.

For example, the controller 101 may be mounted under the dashboard of the vehicle 102 although any other suitable position in the vehicle 102 may be considered.

The controller 101 is programmable and supports secure access. For example, only car dealers having joined a program associated with the system 100 for the prevention of car accidents may be allowed to access data stored in the controller 101 data and/or modify the parameters of the controller via an interface 103 for the connection, programming and data transfer.

The controller 101 also includes a positioning module 104, such as a GPS (Global Positioning System) module to determine the geographical position of the vehicle 102 on the road network.

The controller 101 further includes a processor 105 with a data storage memory 106. The processor 105 is connected to the positioning module 104 to gather information on the geographical position of the motor vehicle 102 on the road network and stored in the storage memory 106. The processor 105 is also connected to the electronic system (not shown) of the motor vehicle 102 by a link 107 for collecting at least one driving parameter of the vehicle 102, for example the speed or the acceleration of the vehicle 102 on the road network, and for storing the parameters in the data storage memory 106. Finally, the processor 105 is connected to a database 108 containing information related to the legal speed limits and possibly other traffic rules in different areas of the road network.

The controller 101 finally comprises a transceiver 109 connected to a transmit/receive antenna 110. The processor 105 is connected to a transceiver 109 to transmit and receive through the antenna 108 data from a central unit (not shown) of the system for preventing auto accidents 100. The transceiver 109 and antenna 110 may for example be part of a cellular network.

The system 100 for preventing auto accidents also includes a display 111 of warning data received from the processor 105 of the controller 101 being visible for example on the inside of the windshield of the vehicle 102. The display in the windshield allows the driver to view the data displayed without having his eyes off the road in order to improve the safety level.

The system 100 for preventing auto accidents finally includes a control unit 112 for the engine of the vehicle 102, for example for the engine's electrical system. The control unit 112 allows the processor 105 of the controller 101 to control operation of the engine of the vehicle 102, for example to reduce the speed of the vehicle 102, for putting the engine of the vehicle 102 in standby mode for a predetermined time period, or to simply stop, i.e. disallow starting of the engine of the vehicle 102.

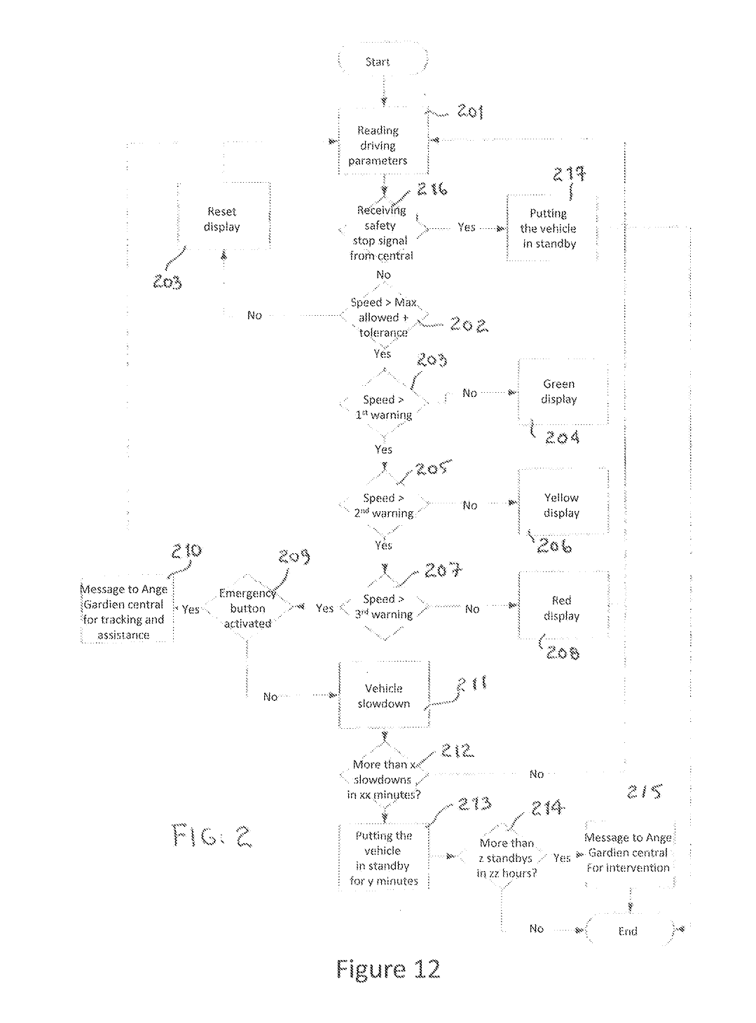

FIG. 12 shows a flowchart of the operation of the system of FIG. 11 in the case of excessive speeding. The vehicle (1) is equipped with the same Ange Gardien™ system, a difference lying in the fact that the Ange Gardien™ module is more finely configured, as explained in the flowchart of FIG. 12, notably the fact that information related to deceleration are deemed necessary and sent to the vehicle causing the immobilization of the vehicle if they occur in a certain rate, allowing for example no more than three (3) excessive speeding events in a one hour period.

Operation 201: So, the processor 105 of the controller 101 reads, for example, the geographical position of the vehicle 102 on the roads as determined by the positioning module 104, the speed limit for the geographic position of the vehicle 102 on the road network extracted from the database 108, and the speed of vehicle 102 obtained from the electronic system (not shown) of the vehicle 102 via the link 107. The geographical position of the vehicle 102 on the road network, the speed limit at the position of the vehicle 102 on the road network, and the speed of the vehicle speed 102 are then stored in the data storage memory 106.

Operation 202-217: The processor 105 of the controller 101 then compares (operation 202) the stored values, i.e. the speed of the vehicle 102, the speed limit at the position of the vehicle 102 on the road network. When the speed limit is not exceeded, no signal or command is sent by the processor 105 to the warning data display 111. The display 111 is then updated (operation 203): Upon detection (operation 202) of a first excessive speed occurrence by the vehicle 102, the processor 105 is programmed to determine whether this is:
a minor infraction (operation 203 or 205), for example, driving at 110 km/h in a 100 km/h speed zone or any other preprogrammed infraction that is deemed tolerable. Of course, other types of infractions may be considered minor, or
a major infraction (operation 207) classifiable as dangerous driving, such as driving at 80 km/h in a pedestrian crossing zone with a 30 km/h speed limit, or any other preprogrammed infraction that is deemed intolerable. Of course, other types of infractions can be considered major.

Upon detection of a first minor infraction (operation 203), the processor 105 records the infraction in the data storage memory 106 and a signal or instruction is transmitted to the display 111 that shows, for example, a green circle on the inside of the windshield 113 (operation 204). The green circle is the symbol of a minor infraction and informs the driver of his behavior.

Upon detection of a second excessive speeding occurrence by the 102 in the same or another area of the road network (operation 202), the excess is considered by processor 105 as second minor infraction, as defined above (operation 205), processor 105 is programmed to classify the second minor infraction associated with a risk (intermediate infraction) for the driver and for the users of the road network on which the vehicle 102 is running. Again, the processor 105 records the intermediate infraction in the data storage memory 106 and transmits a signal or instruction to the display 111 shows, for example, a yellow or orange triangle on the inside of the windshield 113 (operation 206), thereby informing the driver that he is in an intermediate infraction situation.

If, following the detection of the first excessive speeding occurrence (a minor infraction), the detected speed of vehicle 102 continues to increase (operation 202) for example to exceed 110 km/h, the excess is considered by the processor 105 as a second infraction (operation 205) and the processor 105 is programmed to classify the second infraction as a risk (intermediate infraction) for the driver and for the users of the road network on which the vehicle 102 is running. Again, the processor 105 records the infraction in the data storage memory 106 and transmits a signal or instruction to the display 111 that shows, for example, a yellow or orange triangle on the inside of the windshield 113 (operation 206) to inform the driver that it is an infraction situation.

The processor 105 of the controller 101 is programmed to activate an emergency signal for the control unit 112 in order to reduce the speed of the vehicle 102 toward the speed limit for the zone of the road network where vehicle 102 is located (operation 211), for example following a fifth display (operation 206) of a yellow or orange triangle on the inside of the windshield 113 (operation 206). The number 5 can of course be replaced by any other appropriate number.

Following the detection of a major infraction (operation 207) as defined hereinabove, the processor 105 records the infraction in the data storage memory 106 and transmits a signal or instruction to the display 111 that shows, for example, a red square on the inside of the windshield 113 (operation 208) and informs the driver that he is in a major infraction state. From this first display of the red square, the processor 105 of the controller 101 is programmed to activate an emergency signal to the control unit 112 so as to reduce the speed of the vehicle 102 to the speed limit of the area of the road network where the vehicle 102 is located. Of course, displaying a red square corresponds to a high-risk, intolerable behavior for the traffic zone, for example, as mentioned above, when the vehicle 102 is traveling at 80 km/h in the crossing area of a school zone where the speed limit is 30 km/h.

When the processor 105 detects more than a predetermined number imposed decelerations of the vehicle 102 (operation 212), for example 5 or any other number, within a certain period of time, for example 15 minutes or any other time, the motor vehicle 102 is paused or stopped for a certain period of time, e.g. 10 minutes or other time duration (operation 213).

Once paused, the vehicle 102 cannot be restarted by the driver. The processor 105 sends via the transceiver 107 and the transmit/receive antenna 108 an emergency signal to a central unit (not shown) that implicates the police (operation 215).

When the processor 105 detects more than a predetermined number of pauses imposed on the vehicle 102, for example 5 or any other suitable number, within a certain period of time, e.g. 48 hours (operation 214), the processor 105 informs the central unit (not shown) for an intervention (operation 215).

The information about major infractions stored in the data storage memory 106 can be sent to the insurance company by the processor 105 via the transceiver 107 and the transmit/receive antenna 108, for deciding whether or not to increase a premium and/or to the police for issuance of a fine.

The controller 101 of the system for preventing accidents 100 is provided with an emergency module (not shown), such as a button, that can be activated by the driver of the vehicle 102 in case of emergency, such as the need to bring a patient to the emergency ward of the nearest hospital (operation 209). The activation of the emergency unit causes a disconnection of the system for preventing accidents 100 and sends an emergency signal to the central unit (not shown) and/or the police that can verify the validity of the deactivation while being informed of the emergency situation in order to intervene as quickly as possible (operation 210).

Finally, depending on the circumstances, the central unit (not shown) may send a stop signal received by the antenna transceiver 108 and the transceiver 107 (operation 216) to command the processor 105 to place the vehicle 102 in standby for an indefinite period of time (operation 217) leading to the immobilization of the vehicle 102. The stop signal could be motivated and/or justified by the behavior of the driver, i.e. the number, severity and repetition of infractions (operations 203, 205, 207 and 215). At that time, only a dealer adhering to a program associated with prevention system auto accidents 100 may intervene, for example, to restart the vehicle 102 that has been immobilized for an unlimited period of time due to non-compliance with traffic rules, in particular in the case of excessive speeding.

### Example 3

### Vehicle Equipped with a System to Prevent Car Accidents and a Second System to Increase Traffic at a Car Dealership

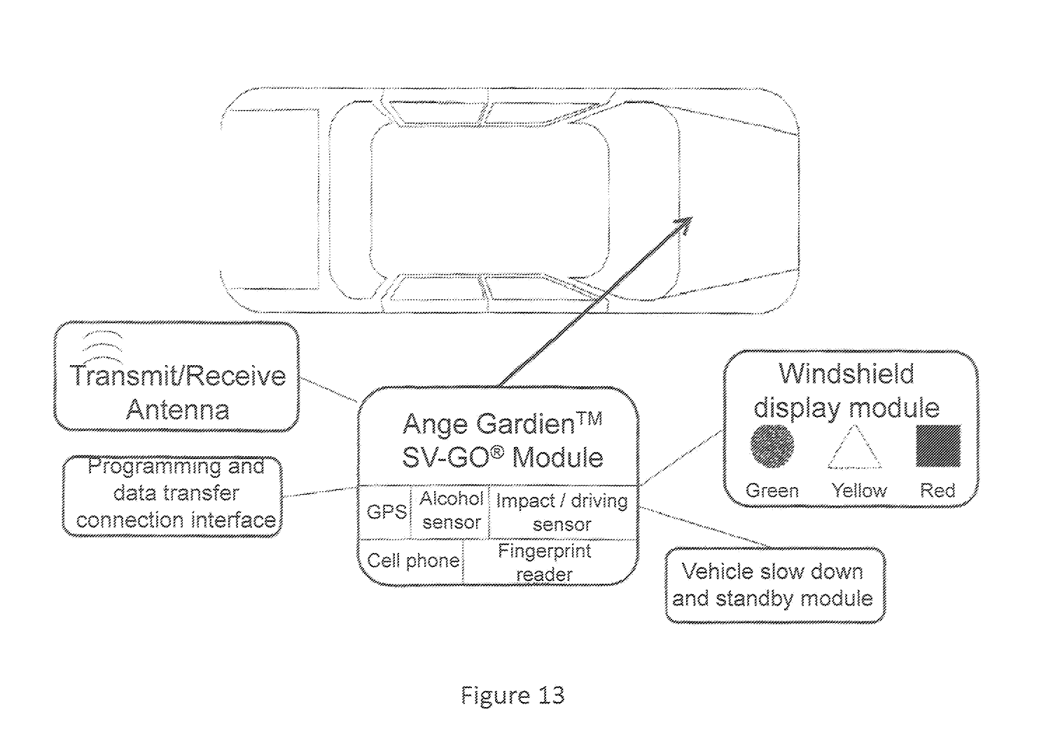

FIG. 13 schematically shows the components of a system according to an embodiment of the present disclosure (Ange Gardien™+SV-go®), the system being for the prevention of car accidents, also showing interconnection of system components. The vehicle (1) described in Examples 1 and 2 is modified so that the Ange Gardien™ module is replaced by an Ange Gardien™+SV-go® (230) module that, independently of the management of risk behaviors, intervenes as soon as there is a broken windshield by informing the dealer.

A glass break detector informs an Ange Gardien™ center as soon as there an impact on the glass, this being used to control/repair the damage before it becomes too large and therefore not repairable. This operation is called an early intervention or recycling prevention. Indeed, glass breakage is a violation of the Highway Safety Code. Such early intervention ensures the integrity of the vehicle and avoids the dangers inherent to the driver.

The driver activates the signaling module that is connected to the SV-go® system and activates it in anticipation making an appointment for the repair and/or replacement of the windshield. In case the driver fails to attend the appointment for repair, a reminder is sent by the Ange Gardien™ center.

The windshield repair being performed early, the importance of the intervention as well as associated costs will be limited.

### Example 4

### Application of the System for People with Disabilities

In this example, the driver is a person who, for example, suffers from memory problems and wants, for herself and her family, to stay within a certain perimeter or travel time for a ride going from point A to point B, or remain within a specific area of travel, including a few businesses or points of interest.

For a driver who fears not find his way while driving because he has previously experienced a loss of memory, not be able to return to his starting point, and for families who are worried whenever the driver takes longer than reasonable to move between two known points, the Ange Gardien™ system can be configured by the central unit, as requested by the driver or his family, to determine a and a maximum perimeter and a maximum allotted time towards a defined destination point, for example a ride towards a store. The Ange Gardien™ system can actually alert the central unit and/or the family and even allow voice communication with the vehicle to reassure and provide the necessary assistance to the driver. This alert occurs if the perimeter is exceeded or if the allotted time is up.

### Example 5

### Vehicle Equipped with a System for the Prevention of Accidents and with Multiple Displays

Driver in Training

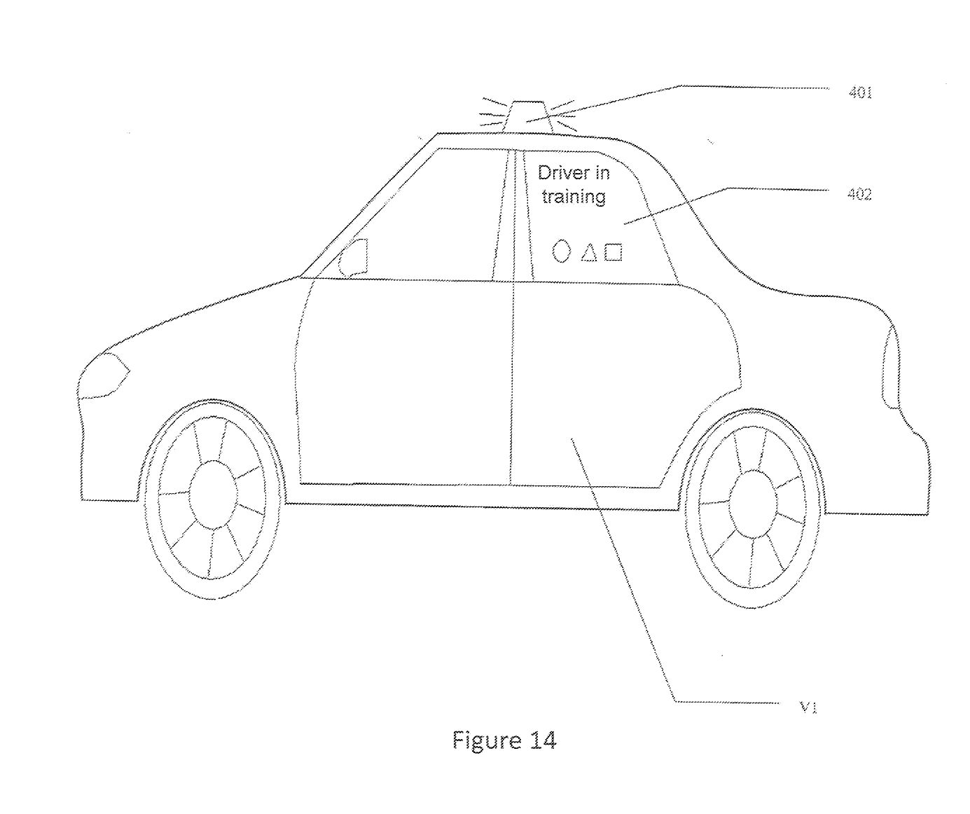

FIG. 14 shows a schematic side view and a vehicle equipped with a system for the prevention of accidents according to an embodiment of the present disclosure, including a display on the rear window, on the front window on the left rear window and a display device on the roof, all in the situation of a driver training. A vehicle V1 is equipped with display means indicating that the driver of vehicle V1 is in training as well as the current state of his driving behavior. More specifically, the display means 401 is positioned on the roof of the vehicle V1 and display means 402 is positioned on each of its two rear side windows. In FIG. 14 and the following Figures, the display means 401 and 402 and following displays means may, in one embodiment, reflect the contents of the display on the windshield as described above. Thus, a sequence of green, yellow (or orange) and red can represent a gradation of risk related to the behavior of the driver of vehicle V1. The gradation of risk can also be represented by symbols such as a circle, triangle and square. A combination may for example comprise a green circle, an orange or yellow triangle or a red square.

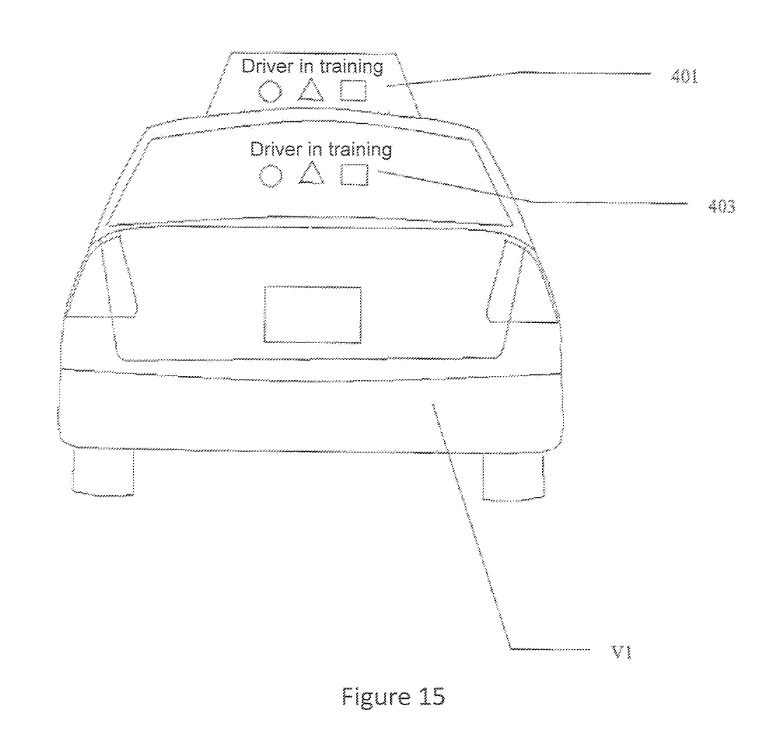

FIG. 15 shows a schematic rear view of the vehicle of FIG. 14. FIG. 15 therefore is a rear view of the vehicle V1. This Figure illustrates the back of the display means 401 and illustrates the display means 403 on the rear window of the vehicle V1.

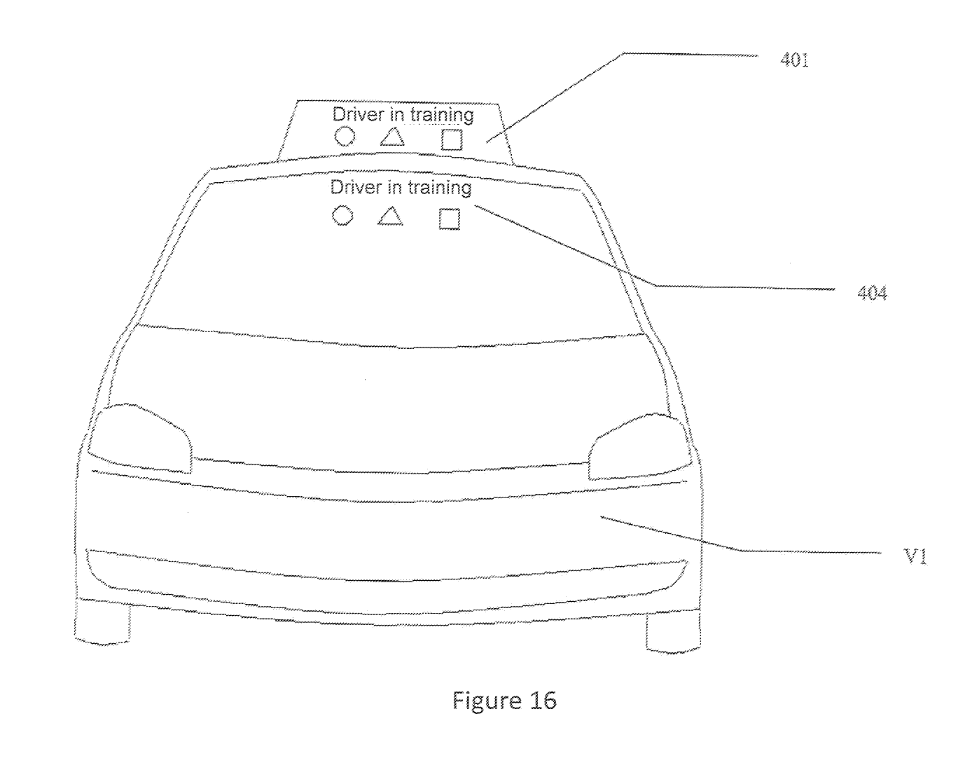

FIG. 16 shows schematically shows a front view of the vehicle of FIG. 14. FIG. 16 is a front view of the vehicle V1. This Figure illustrates the front of the display means 401 and illustrates the display means 404 on the windshield of vehicle V1.

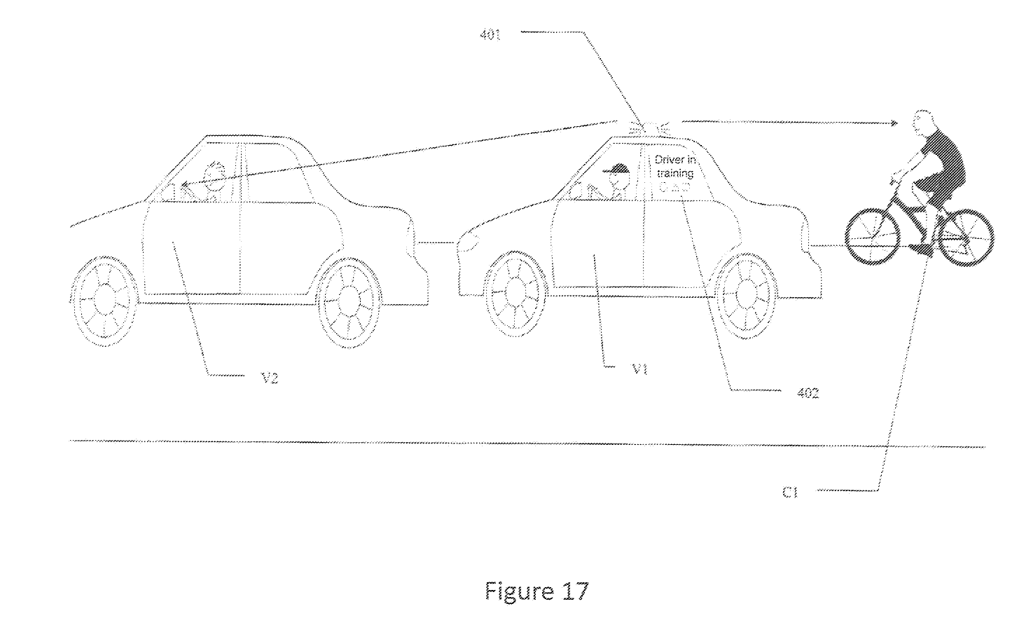

FIG. 17 shows a side view of a vehicle equipped with a system for the prevention of accidents and the driver as well as a vehicle not so equipped rolling in front of the equipped vehicle and a cyclist traveling in behind the equipped vehicle, in a situation where the display system shows “driver in training”. Thus, FIG. 17 shows a situation involving a training driver driving the vehicle V1. In this situation, the driver of the vehicle V2 and the rider C1 are able to see the information from the display means 401, 403 and 404, respectively located on the roof of the vehicle V1 on the rear window of the vehicle V1 and on the windshield of the vehicle V1. This information indicates that the driver of the vehicle V1 is in training as well as the current state of the driving behavior by means of lighted devices. This information thus allows the driver of the vehicle V2 and the rider C1 to adjust their own behavior based on this information.

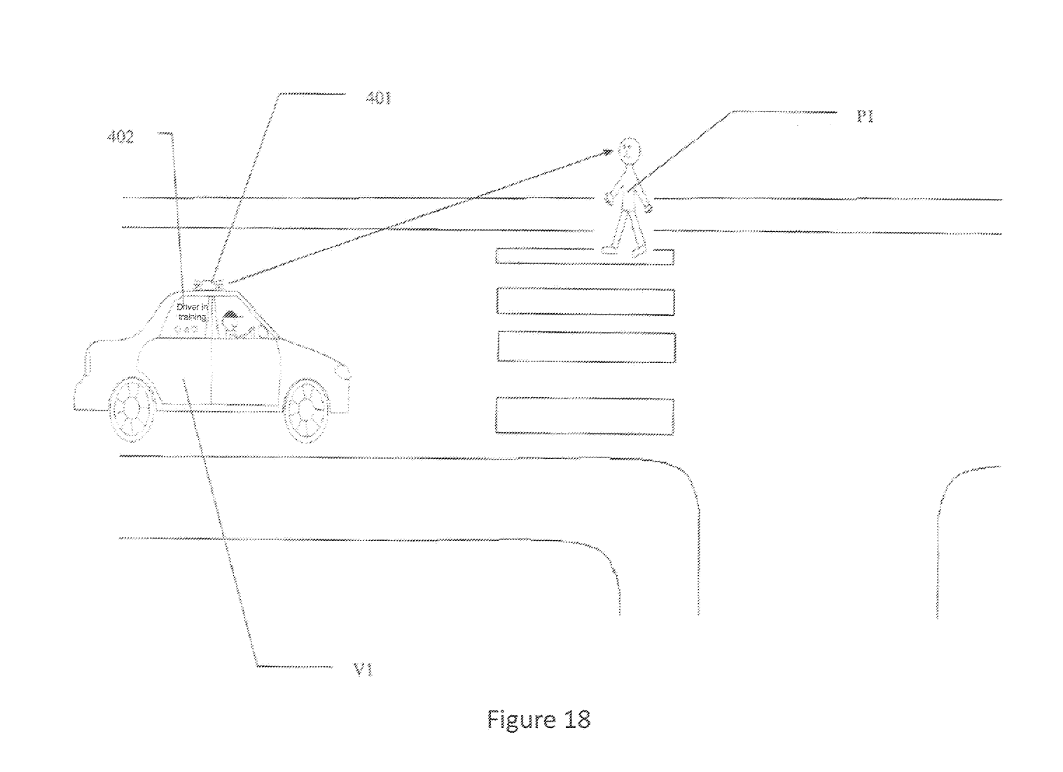

FIG. 18 shows a side view of a vehicle equipped with a system for the prevention of accidents and the driver as well as a pedestrian about to engage a crosswalk while the vehicle is approaching. FIG. 18 thus illustrates a situation where the driver in training approaches the crosswalk with his vehicle V1 when a pedestrian P1 is about to cross the street. At that time, the pedestrian P1 is informed that the driver is training using information from the display means 401, 402 and 404, respectively located on the roof of the vehicle V1 on the rear side windows of the vehicle V1 and the windshield of the vehicle V1. The display means 401, 402 and 404 also informs the pedestrian P1 of the current behavior of the driver in training of the vehicle V1. The pedestrian P1 can thus make a more informed decision before engaging the crosswalk with the confidence that the vehicle V1 will stop.

Driver on Probation

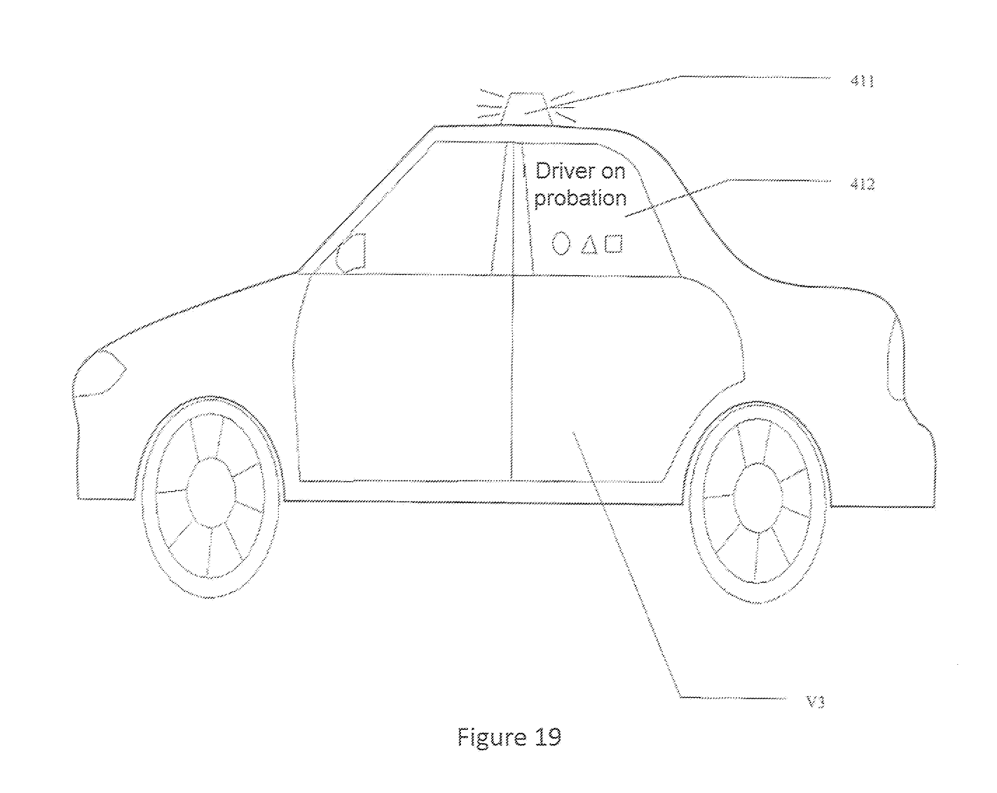

FIG. 19 shows a schematic side view of a vehicle equipped with a system for the prevention of accidents according to an embodiment of the present disclosure, including displays on the rear window, the front window, the left rear window, and on the roof, in the situation of a driver on probation. FIG. 19 is a side view of a vehicle V3 equipped with display means indicating that the driver of the vehicle V3 is on probation, also indicating his current driving behavior. More specifically, the display means 411 is positioned on the roof of the vehicle V3 and the display means 412 is positioned on each of its two rear side windows.

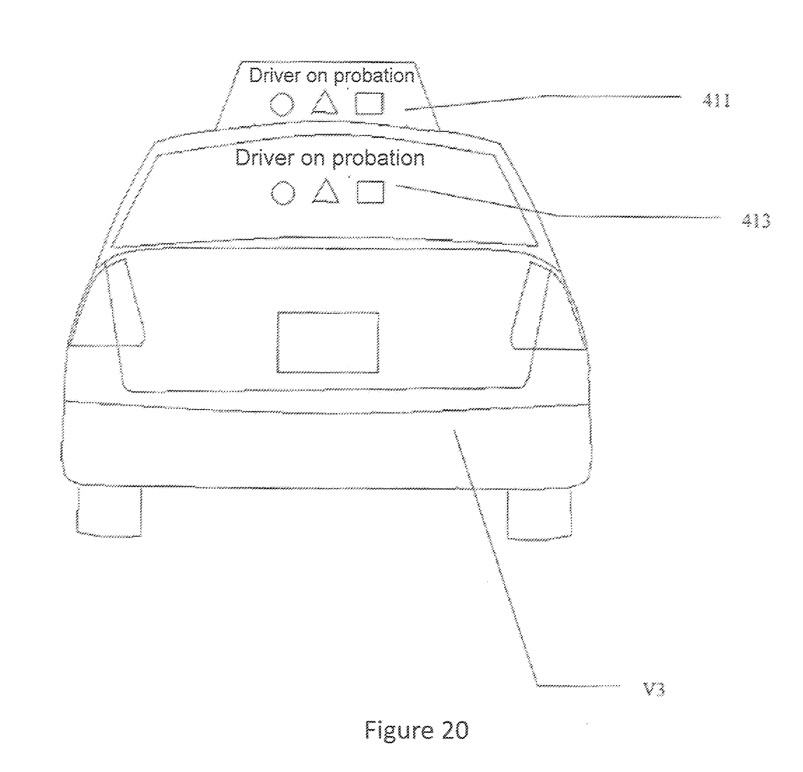

FIG. 20 shows schematically and in rear view the vehicle of FIG. 19. FIG. 20 is a rear view of the vehicle V3. This Figure illustrates the rear of the display through 411, and illustrates the display means 413 located on the rear window of the vehicle V3.

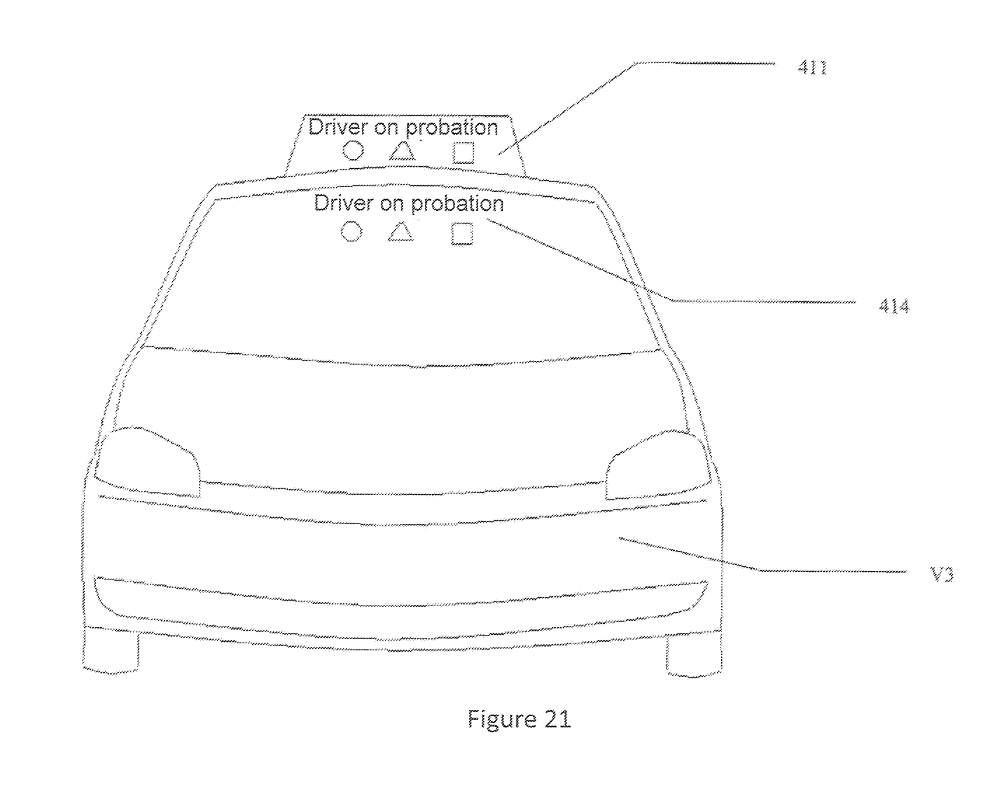

FIG. 21 shows schematically and in front view the vehicle of FIG. 19. FIG. 21 is a front view of the vehicle V3. This Figure shows the front of the display means 411 and shows the display means 414 located on the windshield of the vehicle V3.

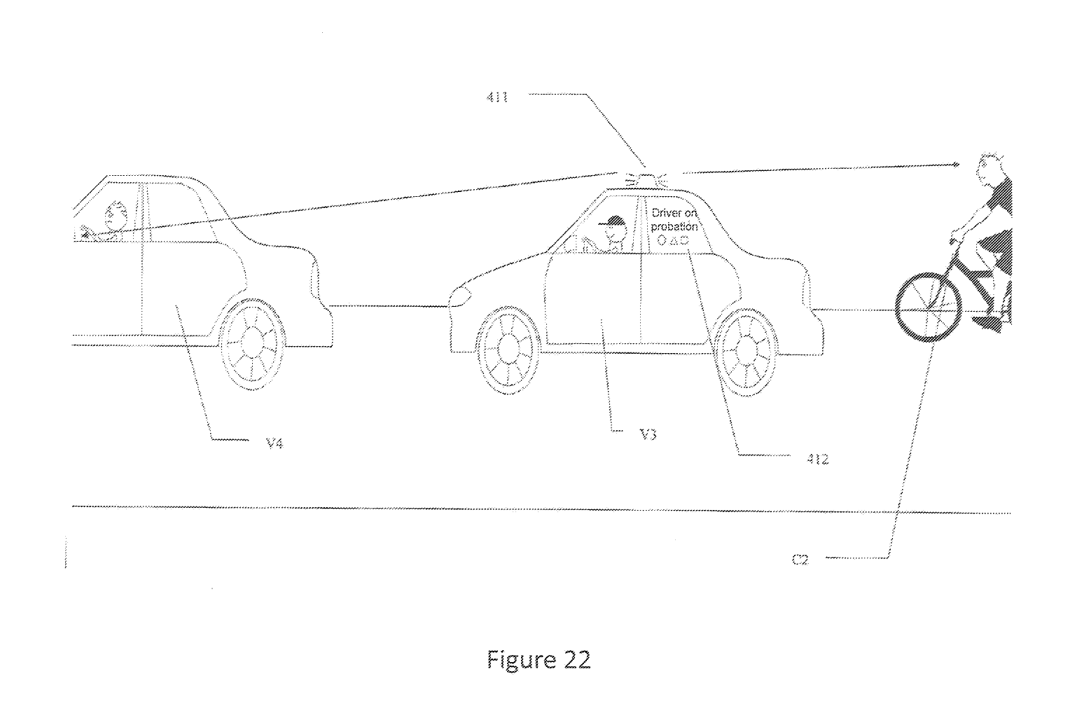

FIG. 22 shows a side view of a vehicle equipped with a system for the prevention of accidents, shown in FIGS. 20 and 21, with its driver, along with a vehicle not so equipped rolling in front of the equipped vehicle and cyclist rolling behind the equipped vehicle, in a situation where the display system shows “driver on probation”. FIG. 22 thus represents a situation involving a driver on probation at the wheel of the vehicle V3. In this situation, the driver of the vehicle V4 and the cyclist C2 are able to see the information from the display means 411, 413 and 414, respectively located on the roof of the vehicle V3, on the rear window of the vehicle, and V3 on the windshield of the vehicle V3. This information indicates that the driver of the vehicle V3 is undergoing training and the current state of his driving behavior by means of lighted devices. This information then allows the driver of the vehicle V4 and the cyclist C2 to adapt their own behavior based on this information. Noting that the vehicle V3 is on probation and is potentially dangerous, they can then keep a greater distance with the vehicle V3 and stay alert to reduce the risk of accidents.

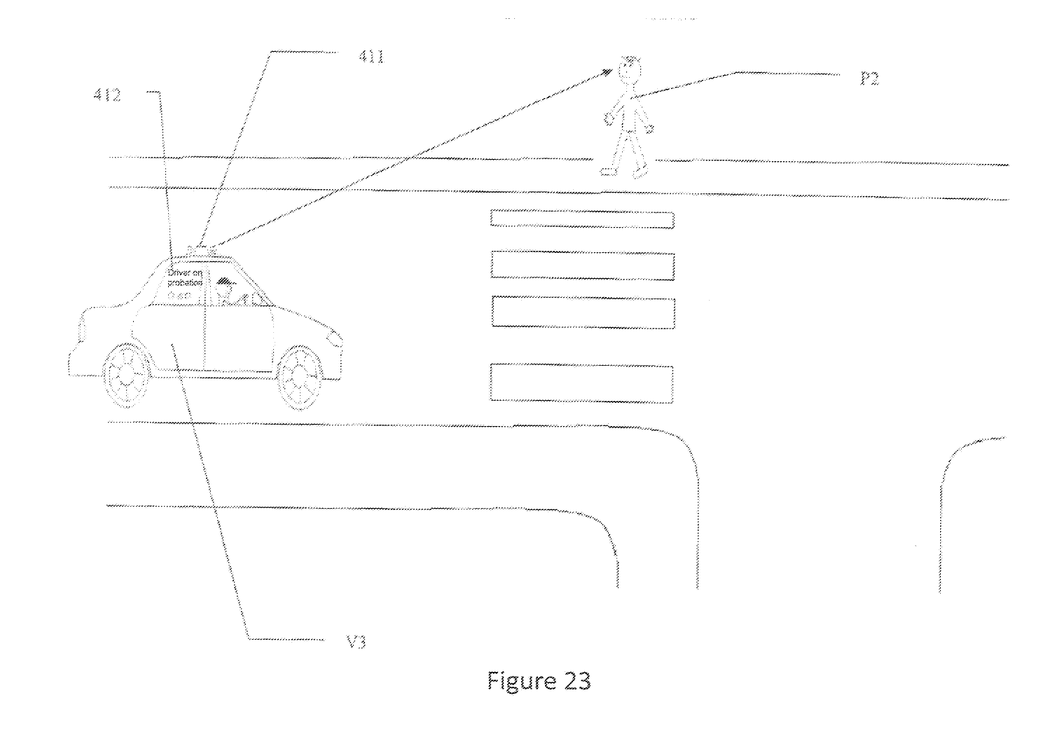

FIG. 23 is a side view of a vehicle equipped with a system for the prevention of accidents with its driver, also showing a pedestrian about to cross a crosswalk while the vehicle is approaching, the vehicle displaying the words “driver on probation”. FIG. 23 thus illustrates a situation where the driver on probation approaches the crosswalk with his vehicle V3 when a pedestrian P2 is about to cross the street. At that time, the pedestrian P2 is informed that the driver is in training using information from the display means 411, 412 and 414, respectively located on the roof of the vehicle V3, on the rear side windows of the vehicle V1, and on the windshield of the vehicle V3. The display means 411, 412 and 414 also inform the pedestrian P2 of the current state of the behavior of the driver in training of the vehicle V3. The pedestrian P2 can make a more informed decision to know if he can commit to enter the crosswalk with the confidence that the vehicle V3 will stop. Knowing that the driver of the vehicle V3 is on probation and is potentially dangerous, the pedestrian P2 may prefer to stay on the sidewalk until the vehicle V3 has left.

In the embodiments shown in FIGS. 14-23, a display module can be realized using lamps such as those used in “Maglite” type lamps, fed with voltage at about 3 volts.

Presence of a GM862 GSM module from TELIT in the case of a proximity to semiconductor amplification circuits were made to work through the establishment of voice transfer via a “Bluetooth” module (WT32 from Blue Giga) developed to work in differential mode.

The GM862 being developed in differential mode, the connection between the latter and the WT32 module without additional semiconductor component is possible and the sound quality is free from noise disturbance.

### CONCLUSION

It has been found, surprisingly, that the systems of the present disclosure, when installed and configured in a motor vehicle, have a direct impact on driver behavior and provide one or more of the following characteristics:
greater efficiency;
a reduction in loss of attention;
an educational effect;
a preventive effect;
a deterrent effect;
a documentary effect; and
a reduction in accidents notably caused by momentary loss of attention, lack of experience, emotions and/or fatigue, or limited capability.

It has also been found that vehicles equipped with the system of the present disclosure and with the SV-go® loyalty system bring a reduction in the number of accidents and a greater loyalty to a dealer.

The present disclosure also provides the driver with information to assess the quality or non-quality of his driving. This information may result awareness that he:
is monitored and a non-respectful behavior with regards to applicable traffic regulations leads, sooner or later, and possibly instantly, to sanctions while a behavior respectful of applicable traffic regulations is likely to, sooner or later, and possibly instantly, bring a reward (such as a reduction in insurance premiums, a gasoline credit, free entry to a cinema, etc.); and/or
is protected by the system that acts as a guardian angel in warning him when placed in a situation that is dangerous for himself or for other users of the road.

For a driver inclined to disregard traffic regulations, the system provides effective monitoring, sends warnings and intervenes if the warnings are not observed or if the driver is placed in a situation that is dangerous for himself and/or for other users of the road.

For a driver respectful of traffic rules, whether tired, insecure, inexperienced and/or with a limited nervous concentration due to stress or emotional disabilities, the Ange Gardien™ system brings protection, security, education, and guides the decision making process. Indeed, a tired driver realizing he is making repeated mistakes may himself decide to take a rest before hitting the road again.

Those skilled in the art will realize that the description of the systems, processes, vehicles and methods for the prevention of accidents are presented here for illustrative purposes only and are not intended to limit in any way the present disclosure. Other embodiments will be readily apparent to those persons skilled in the art upon reading this disclosure. In addition, the disclosed subject-matter can be adapted to the needs of customers to provide valuable solutions to existing problems related to preventing auto accidents.

In the interest of clarity, some well-known elements for implementing the systems, processes, vehicles and methods for the prevention of accidents elements are not shown or described. It will be appreciated that, naturally, in the development of an actual implementation of the systems, processes, methods and vehicles, many decisions specific to a particular embodiment may be required in order to meet the specific goals of a designer, according to constraints of system, network, or according to market situations, and that these specific goals will vary from one implementation to another and from one designer to another. In addition, it will be appreciated that a development effort might be complex and time consuming, but would nevertheless be a normal activity for a person having ordinary skill in the field of the prevention of car accidents having benefited from the present disclosure.

According to the present disclosure, the components, process steps, and/or data structures described hereinabove may be implemented using a variety of, operating systems and computing platforms, network devices, computer programs, and/or general purpose machines. In addition, those skilled in the art will appreciate that universal use mechanisms r, such as hardware devices, field programmable gate arrays (FPGAs), application specific integrated circuits (ASIC), or analog circuits can also be employed. Where a method comprising a series of process steps is implemented by a computer or a machine, these process steps can be stored as a series of instructions readable by a machine, and can be stored on a physical medium.

The systems and modules described hereinabove may include software, firmware, hardware, or any combination of software, firmware or hardware appropriate for the purposes described above. The software and other modules can reside on servers, workstations, personal computers (PCs), computer tablets, personal digital assistants (PDA), or other devices suitable for the purposes described above. Software and other modules may be accessed via a local memory, via a network, via a browser, or other application, or through other means appropriate for the purposes described hereinabove. The above described data structures may include computer files, variables, programs, or any other arrangement or method of storing electronic data, or any combination useful for the above described purposes.

Although the present disclosure has been described using specific implementations, it is understood that many variations and modifications may be implemented, and that this disclosure is intended to cover such modifications, uses or adaptations of the present disclosure that in general follow the principles of the present disclosure, including any variation of the present description that will become known or conventional in the field of endeavor of the present disclosure and that can be applied to the above mentioned elements, in accordance with the scope of the following claims.

What is claimed is:

1. An accident prevention system, the system suitable for installation in a vehicle, comprising:
a device for measuring at least one driving parameter of the vehicle;
a controller supplied with at least one traffic rule in order to detect, in response to the at least one driving parameter, one or more traffic violations by a driver of the vehicle; and
a display, visible from outside the vehicle, of data related to the one or more traffic violations.

2. An accident prevention system according to claim 1, comprising an accelerometer for detecting the at least one driving parameter.

3. An accident prevention system according to claim 2, wherein the accelerometer is vertical axis accelerometer.

4. An accident prevention system according to claim 2, comprising a data storage memory connected to the controller for storing a measurement obtained by the accelerometer.

5. An accident prevention system according to claim 2, wherein the accelerometer is configured to detect a driving condition selected from the group consisting of rolling on the shoulder of a road, an axial impact on the vehicle, an avoidance maneuver, cutting the path of another vehicle, running off the road, and an acceleration exceeding a predetermined threshold.

6. An accident prevention system according to any one of claims 1 to 5, comprising:
a transmitting/receiving device coupled to the controller and configured to transmit to a central unit the at least one driving parameter of the vehicle and to receive from the central unit at least one instruction for the controller;
wherein the controller is configured to modify the display of the data related to one or more traffic violations in response to the at least one instruction.

7. An accident prevention system according to claim 6, wherein the controller is further configured to change a parameter setting of the vehicle electrical system in response to the at least one command.

8. An accident prevention system according to any one of claims 1 to 7, wherein the controller is configured to modify a parameter setting of the vehicle electrical system upon detection of a predetermined number of traffic violations.

9. An accident prevention system according to any one of claims 1 to 8, comprising a controller connected to a physical interface, wherein the interface is configured to allow identification of the driver so as to program the controller based on a profile of the driver.

10. An accident prevention system according to any one of claims 1 to 9, further comprising a display, visible to the driver, of the data related to the one or more traffic violations.

11. An accident prevention system according to any one of claims 1 to 10, wherein the display of the data related to the one or more traffic violations comprises a plurality of elements that can be distinguished by their colors, their shapes or a combination of their colors and shapes.

12. An accident prevention system according to claim 11, wherein a sequence of green, yellow or orange, and red and represents a gradation of risk related to a behavior of the driver.

13. An accident prevention system according to claim 11, wherein a sequence of a circle, a triangle and a square represents a gradation of the risk related to a behavior of the driver.

14. An accident prevention system according to any one of claims 1 to 13, wherein the display of data related to the one or more traffic violations comprises an element selected from the group consisting of a display device on the rear window of the vehicle, a display device on a side window of the vehicle, a display device on the roof of the vehicle, a display device embedded in the body of the vehicle, and a combination thereof.

15. A method for installing the accident prevention system as claimed in any one of claims 1 to 14, comprising installing the device for measuring and the controller in the vehicle and installing the display so as to be visible from outside of the vehicle.

16. An automobile characterized in that it is equipped with the accident prevention system according to any one of claims 1 to 14.

17. Use of a system according to any one of claims 1 to 14, or as obtained by the method of claim 15, or use of a vehicle according to claim 16 for preparing a report on a behavior of the driver of the vehicle.

18. Use of a system according to any one of claims 1 to 14, or as obtained by the method of claim 15, or use of a vehicle according to claim 16 for warning persons outside of the vehicle of a behavior of the driver of the vehicle.

19. An automobile accident prevention method, comprising:
measuring at least one driving parameter of the vehicle;
detecting, by a controller supplied with at least one traffic rule, in response to the at least one driving parameter, one or more traffic violations by a driver of the vehicle; and
displaying data related to the one or more traffic violations so that the data is visible from outside the vehicle.

20. An accident prevention method according to claim 19, wherein the at least one driving parameter is a measure of vehicle acceleration.

21. An accident prevention method according to claim 20, comprising storing the vehicle acceleration measurement.

22. An accident prevention method according to claim 20, wherein the measure of vehicle acceleration provides for detection of a driving condition selected from the group consisting of rolling on the shoulder of a road, an axial impact on the vehicle, an avoidance maneuver, cutting the path of another vehicle, running off the road, and an acceleration exceeding a predetermined threshold.

23. An accident prevention method according to any one of claims 19 to 22, comprising:
transmitting the at least one driving parameter of the vehicle to a central unit;
receiving at least one instruction from the central unit; and
modifying the display of the data related to one or more traffic violations in response to the at least one instruction.

24. An accident prevention method according to claim 23, comprising changing a parameter setting of the vehicle electrical system in response to the at least one command.

25. An accident prevention method according to any one of claims 19 to 24, comprising modifying a parameter setting of the vehicle electrical system upon detection of a predetermined number of traffic violations.

26. An accident prevention method according to any one of claims 19 to 25, comprising programming the controller based on a profile of the driver.

27. An accident prevention method according to any one of claims 19 to 26, further comprising additional displaying the data related to the one or more traffic violations so that the data is visible to the driver.

28. An accident prevention method according to any one of claims 19 to 27, wherein displaying the data related to the one or more traffic violations comprises displaying a plurality of elements that can be distinguished by their colors, their shapes or a combination of their colors and shapes.

29. An accident prevention method according to claim 28, wherein a sequence of green, yellow or orange, and red represents a gradation of risk related to a behavior of the driver.

30. An accident prevention method according to claim 28, wherein a sequence of a circle, a triangle and a square represents a gradation of the risk related to a behavior of the driver.
